(19) United States
(12) Patent Application Publication
(10) Pub. No.: US 2025/0052658 A1
(43) Pub. Date: Feb. 13, 2025

(54) SURFACTANT TEST KIT

(71) Applicant: ECOLAB USA INC., St. Paul, MN (US)

(72) Inventors: Claire Lucille Notermann, Sunfish Lake, MN (US); Sukhwan Soontravanich, Inver Grove Heights, MN (US); Jennifer Stokes, Rosemount, MN (US); Samuel Martin, Saint Paul, MN (US)

(73) Assignee: ECOLAB USA INC., St. Paul, MN (US)

(21) Appl. No.: 18/799,300

(22) Filed: Aug. 9, 2024

Related U.S. Application Data
(60) Provisional application No. 63/518,605, filed on Aug. 10, 2023.

(51) Int. Cl. G01N 13/02; G06T 7/00

(52) U.S. Cl. CPC G01N 13/02; G06T 7/0002

(57) ABSTRACT

Methods, test kits, and compositions for measuring and detecting surfactant concentration in a composition. The method comprises taking a sample of a composition, placing the sample on a substrate, and evaluating the concentration of surfactant in the composition based on appearance of the sample on the substrate. Various substrates can be used to track the spread, distance traveled, and travel time of the sample on the substrate. A substrate is calibrated for use with a particular composition. A mobile application may be used with the substrate to measure the surfactant concentration.

### CROSS-REFERENCE TO RELATED APPLICATION(S)

This application claims priority to U.S. Application No. 63/518,605, filed on Aug. 10, 2023, the disclosure of which is hereby incorporated by reference in its entirety.

### FIELD

The present disclosure is related to compositions, test kits, and methods of detecting and measuring surfactant concentration in a solution. Surfactant concentration is measured or detected using a visual indicator on a substrate and/or accompanying mobile application.

### BACKGROUND

Surfactants are an important part of the cleaning process in a variety of industries. Surfactants can enhance cleaning capabilities by reducing surface tension and aiding in removal of stubborn soils. Surfactants also promote the wetting and dispersion of the cleaning agents, enabling effective penetration into hard-to-reach areas. Surfactants solubilize oils, greases, and other residues, facilitating their removal during rinsing cycles. Surfactants help prevent redeposition of removed soils. Surfactants are also beneficial in helping raw materials remain in a single phase in solution, which allows formulators greater flexibility in the selection of raw materials for use in cleaning formulas. Finally, surfactants can be selected to generate or prevent foam formation depending on the desired application. Their compatibility with different cleaning agents and their ability to adapt to various temperatures and pH ranges make surfactants helpful for optimizing cleaning processes across a wide range of industries.

Certain cleaning applications rely on the addition of a cleaning composition or the dilution of a concentrate composition. User error, improper dilution, and too much or too little cleaning composition can cause undesirable results. Maintaining proper surfactant concentration in a cleaning solution is crucial for achieving effective cleaning results, and deviations from the desired levels can pose significant challenges. Insufficient surfactant concentration can lead to inadequate wetting, poor soil removal, and reduced cleaning efficiency. On the other hand, excessive surfactant concentration can result in problems such as foaming, increased cost, and potential residue formation. Foaming can interfere with equipment operation, hinder rinsing processes, and even lead to product contamination. Additionally, higher surfactant concentrations can be more difficult to rinse off, leaving behind unwanted residues that may compromise the quality and safety of the cleaned surface. Therefore, controlling and monitoring of surfactant concentration in cleaning solutions is important to ensure desired cleaning performance while minimizing undesirable effects. It is against this background that the present disclosure is made.

### SUMMARY

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

Disclosed herein is a method of measuring a concentration of surfactant in a composition, the method comprising: depositing a quantity of a sample of the composition on a target region on a substrate made of a material; obtaining an image of the sample on the target region of the substrate, and processing the image to determine a percentage fill of the target region; and inputting the percentage fill of the target region into an algorithm based upon the material, the surfactant, and the composition to determine the concentration of the surfactant.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is an example of a substrate for use with the methods and test kits described herein.

FIGS. 2A-2C are examples of a substrate for use with the methods and test kits described herein.

FIGS. 3A-3C are examples of a substrate for use with the methods and test kits described herein.

FIGS. 4A-4C are examples of a substrate for use with the methods and test kits described herein.

FIG. 5 is an example network environment in which aspects of the present disclosure may be implemented.

FIG. 6 is a flowchart of an example method of using the mobile application described herein.

FIG. 7 is an example user interface of the mobile application described herein.

FIG. 8 is a block diagram of an example computing system.

FIGS. 9A-9B are visual representations of the results of Example 2.

FIG. 10 is a visual representation of the results of Example 2.

FIG. 11 is a visual representation of the results of Example 4.

FIG. 12 is a graphical representation of the results of Example 4.

FIG. 13 is a visual representation of the results of Example 4.

FIG. 14 is a graphical representation of the results of Example.

FIG. 15 is a visual representation of the results of Example 5.

FIG. 16 is a graphical representation of the results of Example 5.

FIGS. 17A-17D are graphical representations of the results of Example 6.

FIGS. 18A-18B are graphical representations of the results of Example 7.

FIG. 19A is a visual representation of the results of Example 8.

FIG. 19B is a graphical representation of the results of Example 8.

### DETAILED DESCRIPTION

As used herein, weight percent (wt. %), percent by weight, % by weight, and the like are synonyms that refer to the concentration of a substance as the weight of that substance divided by the total weight of the composition and multiplied by 100.

As used herein, the term “about” modifying the quantity of an ingredient in the compositions of the invention or employed in the methods of the invention refers to variation in the numerical quantity that can occur, for example, through typical measuring and liquid handling procedures used for making use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about,” the claims include equivalents to the quantities.

As used herein in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

Described herein is a surfactant test kit for measuring the concentration of a surfactant in a solution, such as a cleaning solution for use in manual cleaning, surface cleaning, or a clean-in-place (CIP) system. In some examples, the surfactant test kit described herein is for use in a field setting to quickly test the presence and/or concentration of a surfactant in a cleaning solution using a simple test kit. In some examples, the test kit uses a substrate that will visually show if the concentration of surfactant is correct, or too high or low. This substrate can include a coupon, a test strip, an adsorbent cloth, and other examples described herein. In some examples, the test kit is used to show the absence of surfactant. More specifically, the test kit can be used on a food or beverage product as proof that the surfactant in the cleaning composition was sufficiently rinsed and the product has not been contaminated with residual surfactant. In other examples, the test kit is used with a mobile application to measure the surfactant concentration. In some examples, other instrumentation and software can be used to measure surfactant concentration, including Image J analysis, spectrophotometers, colorimeters, calibration curves, or other instruments or forms of analysis.

Also described herein are methods for measuring the concentration of surfactant in a composition. In some examples, the methods use the surfactant test kit to measure the concentration or presence of a surfactant. In some examples, the methods and test kits described herein are for use in the field or by customers to easily measure and detect the presence of surfactant in a cleaning system. The methods and test kits may be particularly relevant in cleaning settings where dyes and tracers cannot be used due to cleaning requirements, or in settings where compositions must be food or feed grade compliant and/or GRAS approved for use in food or beverage production or as part of animal feeds. The methods and test kits are also beneficial because they are simple, low-cost, and do not require expensive or specialized equipment, such as a bubble tensiometer.

In some examples, the method comprises taking a sample of a composition, wherein the composition comprises at least one surfactant. The composition may be a cleaning solution used in a manual cleaning application, CIP, or other cleaning application. The cleaning solution may be used in a food and beverage facility, a healthcare facility, a hospital, a restaurant or kitchen facility, a textile care or laundry facility, a water facility, a mining facility, a pharmaceutical plant, a consumer household, a laboratory, and other facilities where cleaning activities are performed.

The composition may be a concentrate solution, a use solution, a diluted use solution, a circulating CIP solution, or any other surfactant-containing solution. The disclosure contemplates measuring the surfactant concentration for any solution that includes surfactant. In some examples, the methods and test kits described herein are calibrated to a particular type of solution. For example, there may be a method and test kit associated with a concentrate solution containing a particular surfactant, and there may be a second method and test kit associated with a use solution or a circulating CIP solution containing that same surfactant. Compositions in a solution or a CIP system may be directly tested in the field, for example, by taking a sample of a surfactant-containing solution to measure surfactant concentration.

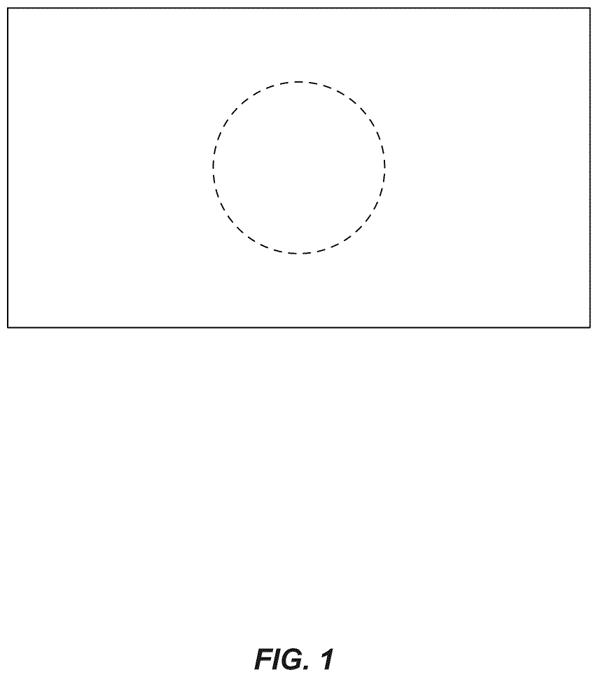

A sample of the composition comprising the at least one surfactant is taken from the larger supply of the composition, and the sample is placed on a substrate. The larger supply of the solution may be a ready-to-use (RTU) solution or other formulated product for use in cleaning applications. The substrate may be any suitable substrate used for testing surfactant presence and concentration. In some examples, the substrate is a polycarbonate coupon or other hydrophobic plastic substrate, an example of which is shown in FIG. 1. In some examples, the substrate is glass, metal, or a polymeric surface such as polyethylene, polycarbonate, polypropylenepolyvinyl chloride (PVC), polyurethane, silicone, or fluoropolymers like polytetrafluoroethylene (PTFE).

In some examples, any substrate may be used, including a non-hydrophobic substrate, that has a hydrophobic coating applied to the surface. The hydrophobic coating may be applied by wiping, spraying, rolling, painting, dipping, or any other suitable method of placing a coating on the substrate. The hydrophobic coating may be a liquid or a solid, and the coating may dry, harden, and/or cure on the surface of the substrate. In some examples, hydrophobic refers to the tendency to repel water. The hydrophobicity of a surface or coating applied to a surface is directly related to the contact angle relative to the surface. In some examples, nanoparticles may be incorporated into a hydrophobic coating to change the hydrophobicity of a surface.

In some examples, the substrate is a polycarbonate coupon, though the entirety of the description related to a polycarbonate coupon is applicable to any other plastic substrate. The polycarbonate coupon may be any suitable size or shape. In some examples, the polycarbonate coupon has an area of less than 25 square inches. In other examples, the polycarbonate coupon has an area of less than 15 square inches. In other examples, the polycarbonate coupon has an area of less than 5 square inches. In other examples, the polycarbonate coupon has an area of less than 3 square inches. The polycarbonate coupon may be any suitable shape such as a square, rectangle, circle, triangle, trapezoid, or other polygon. In some examples, the polycarbonate coupon may have a circle or other shape marked on the surface of the coupon. The shape may be printed onto the coupon or stamped as an impression in the coupon. In some examples, the polycarbonate coupon is clear in color and a circle or other shape is present on a paper or other material sitting underneath the polycarbonate coupon such that the circle or other shape is visible through the clear polycarbonate coupon.

In other examples, the substrate may be a fabric or paper substrate. The fabric or paper substrate can include, but is not limited to, an absorbent cloth (e.g., WYPALL® bonded cellulose cloths produced by Kimberly-Clark Worldwide, Inc.), non-woven polycarbonate cloth, filter paper, or test paper. In some examples, the substrate is any material capable of wicking a liquid, meaning the absorption of a liquid, such as cotton, natural fiber, cellulose, or other similar materials. The fabric or paper substrate may be any suitable size or shape. In some examples, the fabric or paper substrate has an area of less than 25 square inches. In other examples, the fabric or paper substrate has an area of less than 15 square inches. In other examples, the fabric or paper substrate has an area of less than 5 square inches. In other examples, the fabric or paper substrate has an area of less than 3 square inches. The fabric or paper substrate may be may suitable shape such as a square, rectangle, circle, triangle, trapezoid, or other polygon. In some examples, the fabric or paper substrate may have markings or perforations.

The sample may be placed on the substrate in any suitable manner. For example, if the substrate is a polycarbonate coupon, the sample may be pipetted or dripped in one or more drops onto the surface of the polycarbonate coupon. In examples where the substrate is fabric or paper, the sample may also be pipetted or dripped in one or more drops onto the surface of the fabric or paper. In other examples with a fabric or paper substrate, the substrate may be dipped into the sample so that a portion of the fabric or paper substrate contacts the sample.

Once the sample has been placed on the substrate, the method comprises evaluating the concentration of surfactant in the composition based on appearance of the sample on the substrate. The appearance of the sample on the substrate can be compared to a standard calibrated for the particular composition that is being tested. For example, a sample of Composition A on a substrate can be compared to a standard for Composition A with the correct concentration of surfactant. The appearance of the sample compared to the standard can indicate if the sample has the right concentration of surfactant. Different compositions will have different standards and appearances due to differences in chemical composition. Various characteristics of the sample's appearance can be measured.

For example, if the sample is placed on a polycarbonate coupon, the one or more drops on the coupon may spread or bead (i.e., non-spreading). The spreading or non-spreading behavior of liquid drops on a surface can be attributed to numerous factors including surface tension, contact angle, and surface energy. When a liquid drop comes into contact with a surface, its ability to spread or not spread depends on the balance between cohesive forces within the liquid and adhesive forces between the liquid and the surface. If the surface tension of the liquid is higher than the surface energy of the surface, the drop tends to form a compact shape with a high contact angle, resisting spreading. Conversely, if the surface energy of the surface is greater than the surface tension of the liquid, the drop spreads out, forming a thin film with a low contact angle. The interaction between the liquid and surface can also be influenced by factors like chemical composition, pH, and temperature, which can modify the contact angle and determine whether the drop spreads or remains as a compact droplet.

A sample that is placed on a polycarbonate coupon may spread depending on the surface tension of the composition and the surface energy of the polycarbonate coupon. The surface tension of the composition is dependent on the components of the composition, such as the surfactant in the composition. Surfactants can produce differing surface tensions in a composition due to various factors. Surfactants typically consist of both hydrophobic and hydrophilic regions. The balance between these regions affects the overall surface tension of the surfactant. For example, surfactants with higher concentrations of hydrophilic groups tend to have lower surface tensions since they can interact more favorably with water molecules. The packing and orientation of surfactants at interfaces may also impact surface tension. As the concentration of surfactant increases in a composition, the surface tension decreases until it reaches a plateau when the surfactant forms micelles. The length and branching of chains in surfactant molecules can also increase the surface tension of the composition. For example, longer hydrophobic chains tend to increase surface tension due to more intermolecular forces and reduced mobility, while shorter or more branched chains create lower surface tension. Surface tension can also be affected by the presence of counterions and by the pH of the composition.

The spread of one or more drops on a coupon is also impacted by the critical micelle concentration (CMC). The CMC of a composition is the concentration of surfactant in the composition at which the surfactants will form micelles. Before the CMC of a composition is reached, increasing the concentration of surfactant in the composition will continually cause the surface tension of the composition to change. This change in surface tension results in more or less spread of one or more drops of composition. For example, drops of a surfactant at a low concentration below the CMC will spread a certain amount, while drops of the surfactant at a higher concentration, but still below the CMC, will spread a different amount. When the concentration of surfactant in a composition is below the CMC, changes in concentration of the surfactant below the CMC will result in different surface tension, and thus different spread of drops of the composition, allowing for measurement of the spread and surfactant concentration as described herein.

However, when the concentration of surfactant in a composition reaches or exceeds the CMC, the appearance of one or more drops of the composition on a coupon will not change. This occurs because once a composition reaches the CMC, the monomers of surfactant form micelles. The CMC is reached when the amount of a particular surfactant in a composition is high enough that the molecules of surfactant agglomerate with each other to form micelles. A surfactant micelle is an aggregate of surfactant molecules that have arranged themselves in a spherical shape. A typical micelle structure includes the hydrophilic heads of the surfactant molecules facing outward on the outside of the spherical shape and interacting with the composition, while the hydrophobic tails of the surfactant molecules are facing inwardly and are located on the inside of the micelle. Because the hydrophobic tails of the surfactant are now inside of the micelle, the free energy of the composition decreases and the appearance of a drop of the composition on a coupon will not substantively change once the CMC is reached.

The CMC is different for each surfactant in each composition. For example, surfactant A in composition A will have a particular CMC, but surfactant A in composition B will have a different CMC. Further, surfactant B in composition A and surfactant A in a different sample of composition A, the two surfactants will have different CMCs. When multiple surfactants are used in a composition together, the CMC is between the CMCs for each surfactant in the composition alone. The CMC for a mixture of surfactants can be predicted using the CMC of each individual surfactant in the composition and the level of interaction between the surfactants. Therefore, the CMC of a surfactant is specific to the particular surfactant in a particular composition.

When a composition comprising a surfactant comes into contact with soil, the behavior of the composition on a substrate may change. For example, a sample of a composition comprising a surfactant that has been introduced to soil may have a different contact angle or may otherwise change the overall surface tension of the composition and how it interacts with the substrate. Therefore, in some examples, the methods described herein are used to test compositions that have not yet interacted with soil.

The compositions, solutions, methods, and kits described herein require that the concentration of surfactant in a composition is below the CMC such that the spread of one or more drops can be analyzed to determine surfactant concentration.

Since surfactants can have such variable surface tensions, CMCs, and other chemical properties that will impact the surface tension and contact angle, in addition to the surface energy of the substrate, and thus spreading, measuring the concentration or presence of surfactant in a sample is largely dependent on the qualities of a particular surfactant and composition. Therefore, the methods and test kits disclosed herein may be calibrated for specific surfactant(s) and/or compositions. For example, a method or test kit may be designed to measure the presence and concentration of surfactant in one particular commercial cleaning product based on the unique chemical composition and characteristics of that cleaning product.

Therefore, evaluating the concentration of surfactant in the composition based on appearance of the sample on the substrate is dependent on the particular cleaning composition. For example, a polycarbonate coupon can be used that is designed to test the surfactant concentration of a particular composition. The coupon may have a particular surface energy and markings indicating where one or more drops with the correct surfactant concentration will spread to on the coupon. Such markings, or perforations, are referred to as a target spread circle or target region, which is calibrated to a particular cleaning composition.

The target spread circle or target region on a substrate is determined as follows. A composition containing a known amount of surfactant in a correct concentration is used. The “correct” concentration means that the composition comprises the concentration of surfactant that is desirable to impart the necessary properties, such as cleaning and sanitizing. A substrate is selected that is compatible with the particular surfactant-containing composition. Compatibility of a substrate and a composition may be determined by evaluating the spread of the composition on the substrate relative to the concentration of surfactant in the substrate (substrate-composition compatibility discussed more below in Examples 5-6). A quantity of the composition is added to the surface of the substrate and the spread of the composition is measured. Since the concentration of the surfactant in the composition is known to be correct and the substrate has been determined to be compatible with the composition, the spread of the drop on the substrate represents the desired spread of the composition with the correct amount of surfactant. If the substrate is a coupon, a circle can be drawn on the substrate (or on a material to be placed under a clear substrate) that traces the circumference of the composition spread. This represents the circumference of a circle that the same quantity of composition (i.e., a predetermined quantity) should spread on the coupon when the surfactant concentration is correct. If the substrate is a cloth or filter paper, the cloth or filter paper may be dipped into the composition with the correct amount of surfactant, and the distance that the composition travels up the cloth or filter paper represents the target region that a composition with the correct concentration of surfactant should spread. When following the above methods, a substrate can be prepared to be part of a kit for measuring the surfactant concentration of the same composition on the same substrate.

When using the kit as described above, a predetermined quantity of the composition, such as a drop, (which has been pre-tested to be compatible with the substrate in the kit) can be added to the substrate that has the target spread circle on it. When the quantity of the composition is placed within the target spread circle, if the concentration of surfactant is correct, the drop will spread so that the edges of the drop touch the outer perimeter of the target spread circle on the polycarbonate coupon. A target spread circle size is chosen based on the spread of a composition that includes the correct concentration of surfactant to achieve the intended purpose of the composition. Therefore, a surfactant concentration is “correct” if it includes the concentration of surfactant intended to be in the composition to achieve the desired goal of the composition, such as cleaning or sanitizing. A sample of a composition that does not include the correct amount of surfactant will not spread to the circumference of the target spread circle. The sample may spread too far beyond the target spread circle or may not spread enough to reach the circumference of the target spread circle. In some examples, the circle of FIG. 1 can be a band having a radial thickness corresponding to an acceptable surfactant concentration range. In other examples, there may be a plurality of radially nested indicators that correspond to various different levels of surfactant concentration, which permit the user to adjust surfactant levels based upon the reading on the substrate.

The amount of the composition to be added to the substrate varies depending on the composition, type of surfactant, other components of the composition, the substrate, and other factors that would affect spread. In some examples, about 10 μl to about 1,000 μl are used on the substrate. In some examples, about 10 μl to about 900 μl, about 10 μl to about 800 μl, about 10 μl to about 700 μl, about 10 μl to about 600 μl, about 10 μl to about 500 μl, about 10 μl to about 400 μl, about 10 μl to about 300 μl, about 10 μl to about 200 μl, about 10 μl to about 100 μl, about 10 μl to about 75 μl, about 10 μl to about 50 μl, about 10 μl to about 40 μl, about 10 μl to about 30 μl, about 10 μl to about 20 μl, about 20 μl to about 1,000 μl, about 30 μl to about 1,000 μl, about 40 μl to about 1,000 μl, about 50 μl to about 1,000 μl, about 75 μl to about 1,000 μl, about 100 μl to about 1,000 μl, about 200 μl to about 1,000 μl, about 300 μl to about 1,000 μl, about 400 μl to about 1,000 μl, about 500 μl to about 1,000 μl, about 600 μl to about 1,000 μl, about 700 μl to about 1,000 μl, about 800 μl to about 1,000 μl, or about 900 μl to about 1,000 μl are added to the substrate. In some examples, a precise quantity of the composition is added to the substrate to properly evaluate the amount of spread of the composition on the substrate. For example, 25 μl, 50 μl, 75 μl, 100 μl, 150 μl, 200 μl, 250 μl, 300 μl, 350 μl, 400 μl, 450 μl, 500 μl, 550 μl, 600 μl, 650 μl, 700 μl, 750 μl, 800 μl, 850 μl, 900 μl, 950 μl, or 1,000 μl may be added to the substrate.

The disclosure envisages that a polycarbonate coupon is produced for each cleaning composition to be used, and thus different polycarbonate coupons will have target spread circles of different circumferences for different compositions. For example, a polycarbonate coupon used to measure surfactant concentration in a first composition may have a target spread circle with a circumference that is larger than the target spread circle circumference of a polycarbonate coupon used to measure the surfactant concentration of a second composition. Further, the disclosure envisions a polycarbonate coupon for use with the present disclosure will indicate a specific quantity of the composition to be added to it. For example, a polycarbonate coupon associated with a first composition may have a target spread circle as discussed above and may also require that a first quantity of the composition be added, such as 200 μl. For example, the polycarbonate coupon for use with a second composition may require that a second quantity of the composition be added, which may be different from the first composition, such as 100 μl.

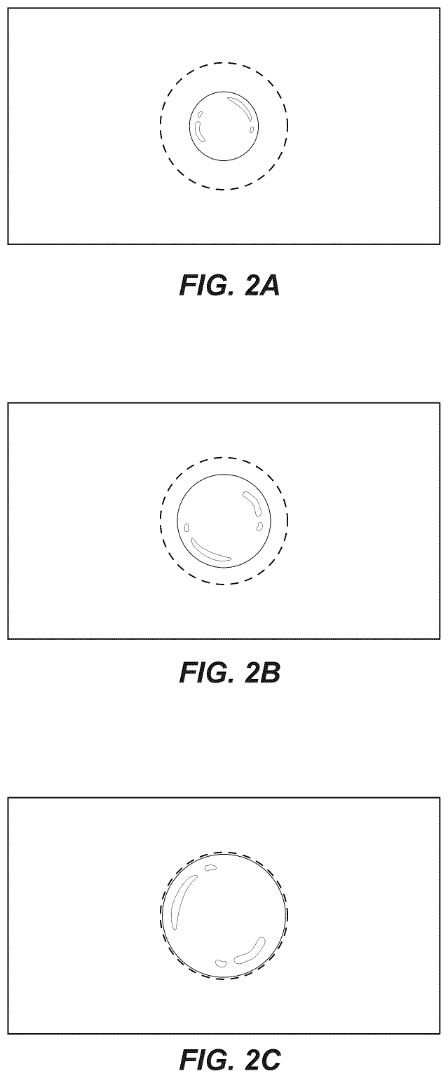

FIGS. 2A-2C illustrates the spread of one or more drops of a sample on a polycarbonate coupon. As shown in FIGS. 2A-2C, a dotted line circle represents a target spread circle on a polycarbonate coupon (the target spread circle is obscured behind the drop in FIG. 2C). In FIG. 2A, the one or more drops of the sample have been placed in the target spread circle, and the drops have not spread to reach the circumference of the circle, meaning the concentration of surfactant in the composition is not correct. In FIG. 2B, the one or more drops of the sample have spread farther than in FIG. 2A and is closer to the target spread circle circumference, meaning that the concentration of surfactant is closer to the correct amount but is still incorrect. In FIG. 2C, the one or more drops of the sample have spread the correct amount and reached, but not exceeded, the circumference of the target spread circle, meaning that the surfactant concentration is correct. If the surfactant concentration in the cleaning composition is correct, then the cleaning composition can deliver the intended cleaning properties. If the surfactant concentration is incorrect, then the cleaning composition may not produce the desired cleaning properties.

Different surfactants may produce different spreads based on their chemical properties and the properties of the substrate. Therefore, too much spread of one or more drops of a sample may mean there is too much or not enough of a surfactant in the composition, and too little spread of one or more drops of a sample may also mean there is too much or not enough of a surfactant in the composition.

A polycarbonate coupon with a target spread circle associated with a particular composition may also include an indicator for that particular composition. For example, a substrate or other component of a test kit may have an indicator that says if the one or more drops do not spread to reach the target spread circle, more surfactant is needed in the composition. Or alternatively, the indicator may say that if the one or more drops do not spread to reach the target spread circle, there is too much surfactant in the composition. Much like the substrate and target spread circle, the indicator is calibrated for the particular composition that is tested. The cleaning composition can be adjusted accordingly by adding more surfactant to the composition, or by adding more dilutant to the composition to dilute the surfactant, and the testing can be performed again until the correct surfactant concentration is reached.

When the one or more drops are placed on the polycarbonate coupon in the center of the target spread circle, the spread of the one or more drops can be measured using the target spread circle or by using any other measurement means, such as a caliper or ruler. The spread of the one or more drops can be compared to a standard, such as the target spread circle that indicates there is the correct concentration of surfactant in the composition. The spread of the one or more drops can be compared to a standard based on the diameter of the spread of the circle as measured by a caliper or ruler.

If a substrate other than a polycarbonate coupon is used, the evaluation of the surfactant concentration based on appearance may vary. For example, if the substrate is a filter paper, such as a Whatman filter paper, one or more drops placed on the filter paper will not bead as with a polycarbonate coupon. Instead, the one or more drops will spread out on the filter paper due to capillary action in which the pores or fibers of the paper create capillary channels that transport liquid across the filter paper. The rate and extent of the spreading on the filter paper depends on the viscosity of the liquid, surface tension, and the porosity of the filter paper. The one or more drops may also absorb into the filter paper (i.e., the liquid is drawn into the pores or fibers of the paper), or the drops may adsorb into the filter paper (i.e., the liquid adheres to the surface of the filter paper due to attractive forces).

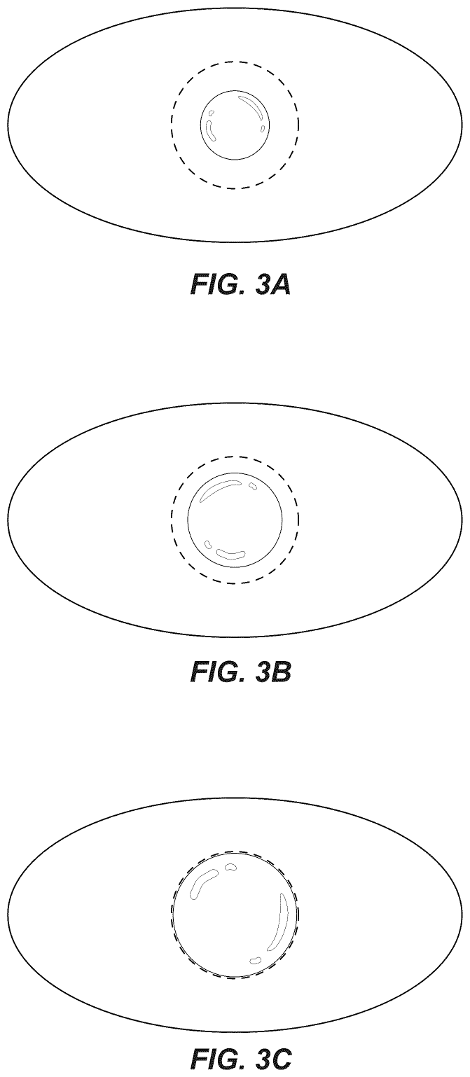

As described above with respect to the polycarbonate coupons, a filter paper may include a target spread circle that includes markings or perforations to indicate the correct amount of spread if the concentration of surfactant in the composition is correct. All of the disclosure above regarding the target spread circle with respect to the polycarbonate coupon applies to the filter paper. FIGS. 3A-3C show examples of a filter paper with a target spread circle. In FIG. 3A, the spread of the one or more drops on the filter paper is less than the circumference of the target spread circle, meaning that the surfactant concentration in the composition is not correct. In FIG. 3B, the one or more drops on the filter paper spread more and is closer to the target spread circle, but the surfactant concentration is still not correct. In FIG. 3C, the one or more drops on the filter paper spread sufficiently to reach the target spread circle, meaning that the surfactant concentration in the composition is correct.

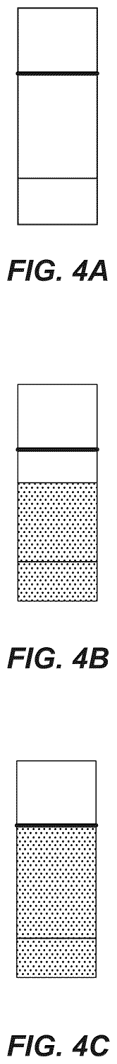

Other paper substrates and fabric substrates can also be used, such as test strips, absorbent cloths, or non-woven cloths. These substrates can be dipped into a sample of the composition, and the spread of the sample up the substrate can be measured. For example, a test strip or non-woven cloth can be cut to a predetermined size with markings on the substrate associated with the correct concentration of surfactant for the particular composition to be tested. For example, there may be a line up to which the substrate should be dipped in the sample, and a target spread line, meaning that if there is sufficient surfactant concentration in the sample, the liquid will spread up to that line. FIGS. 4A-4C show examples of substrates that are dipped in the sample. FIG. 4A shows an example of a test strip, absorbent cloth, or non-woven cloth that has a lower marking indicating that the substrate should be dipped into the sample up to that line, and an upper target spread line. FIG. 4B shows an example where the substrate was dipped into the sample up to the lower line and the liquid only traveled partially up the substrate and did not reach the target spread line, meaning the surfactant concentration in the composition is incorrect. If the substrate is dipped into the sample up to the lower line and the liquid from the sample travels up the substrate to the target spread line, then there is sufficient surfactant concentration in the composition, as shown in FIG. 4C.

With a test strip, absorbent cloth, non-woven cloth, or other substrate that is dipped into the sample, the concentration of surfactant can be evaluated by measuring the distance that the composition travels on the substrate. The concentration can also be evaluated by measuring the time it takes for the composition to travel up the substrate, such as to the target spread line or the top of the substrate. In some examples, the speed with which the composition travels up the substrate correlates to the amount of surfactant in the composition, meaning that the faster the composition travels up the substrate, the more surfactant there is in the composition.

As with all of the substrates disclosed herein, each substrate may be calibrated to be used with a particular composition. Therefore, a polycarbonate coupon designed to be used with a first composition could not accurately be used to measure the surfactant concentration of a second composition that differs from the first composition.

In some examples, any of the substrates described herein can be used to evaluate the concentration of surfactant using Image J analysis to measure the appearance of the sample. Image J analysis may mean that digital images taken of a substrate can be analyzed using Image J software. The software can be used to measure various parameters such as length, area, intensity, shape, pixels, and more from images. Image J analysis can be used to measure the number of pixels in an area of one or more drops on a polycarbonate coupon or filter paper relative to a target spread circle, or it can measure the distance traveled and/or area covered by a sample on a test strip or fabric substrate. The measurements using Image J analysis may allow for a more accurate measurement of the appearance and mobility of a sample to be tested. In some examples, a composition with the correct concentration of surfactant may be measured using Image J analysis as a standard for comparison of how many pixels and how much area the sample should occupy on a substrate if the sample has the correct concentration of surfactant. For example, a first composition with the correct concentration of surfactant may include a set number of pixels and may occupy a certain area relative to a target spread circle, which acts as a standard for comparison. Other samples of that first composition may be tested and compared against the standard with the correct concentration of surfactant.

The disclosed method can also be used on rinse water or product to show proof of the absence of surfactant and ensure that the surfactant has been completely rinsed away. When the method is used to show proof of the absence of surfactant, similar substrates and surfaces can be used but will account for the expected behavior of the rinse water or desired product that is not contaminated with residual surfactant. For example, if used on rinse water, milk, juice, water, beer, wine, ethanol, baby formula, food, beverage, pharmaceutical and the like, a coupon, test strip, or other substrate will indicate the desired circle or pattern for that product without any surfactant contamination. Deviations from that desired circle or pattern may indicate that the product is contaminated with residual surfactant. In that case, further cleaning or rinsing can be done to remove any residual surfactant and then tested again to ensure complete surfactant removal.

In some examples, the methods and test kit described herein can be used with a mobile application. The mobile application may be used with a cell phone, desktop computer, and/or other handheld device. The mobile application may connect to a camera on a cell phone or other handheld device to capture images of the sample on the substrate. For example, the mobile application may measure the size and spread of a droplet or one or more drops on a polycarbonate coupon or other substrate. In some examples, the mobile application may also measure the distance traveled on a substrate by the composition, such as the distance the liquid traveled up a test strip or fabric substrate. The mobile application may also measure the travel time of the liquid composition on the substrate. The mobile application may process and analyze the inputs from the camera to measure these various factors about the substrate and sample. The mobile application may then use the measurements to measure the concentration of surfactant based on the particular composition that the substrate and mobile application are calibrated for. For example, a polycarbonate coupon designed for a first composition must be used with a program in the mobile application associated with the first composition to accurately measure the surfactant concentration based on the chemical properties of that composition. The same polycarbonate coupon and program in the mobile application could not be used to accurately measure the surfactant concentration in a second composition.

In some embodiments, an image may be taken of the substrate with the sample on it (e.g., the droplet on the polycarbonate coupon, the spread of the composition on a fabric substrate, etc.). The following description of the mobile application is with reference to a substrate such as a coupon with a drop on it, but the disclosure envisions a similar mobile application process for other substrates.

The image of the substrate with the sample on it may be taken with a mobile device or other handheld device capable of capturing photographs and uploaded or used in connection with a mobile application. The mobile application may be in communication with a data processor, server, and/or other computer system. For example, the image may be sent to an HTTP Azure Function for processing and read in a suitable program, such as Python Azure Function. The software may modify the image from the camera to improve the image, reduce noise, eliminate errors, eliminate false positives, eliminate false negatives, and the like. For example, the software may convert the image from color to grayscale or blur portions of the image. The mobile application may be programmed to measure multiple circles and return an error message if no circles are detected by the camera or the software. An example of a circle detection program includes Circle Hough Transform. If circles are detected, the mobile application may continue to measure the surfactant concentration. The system may find the largest circle. The original image may be cropped down to the diameter of the detected circle.

Further modifications may be made to the cropped image to further define the edge of the circle and the edge of the drop, including blurring the image, converting the image from color to grayscale, eliminating, excluding, or blacking out any portion of the image not within the circle, and the like. Once the image has been cleaned up, the percent of the droplet filled compared to the circular region of interest may be calculated.

The percent fill of the circle on the substrate can be used to determine a concentration level of surfactant in the solution based on the droplets placed on the substrate, the droplets having a specific quantity of fluid. For particular composition/surfactant pairs, equations can be theoretically or experimentally developed that correlate the quantity of the circle on the substrate that is filled to the amount of surfactant in the composition. Due to the mechanisms by which surfactants modify surface tension and thereby affect extension of the drop on a substrate having consistent surface energy, as described above, the relationship is often a second-order polynomial one taking the form of

$$y = α x \hat{} 2 + β x + γ \qquad [ Equation 1 ]$$

where α, β, and γ are dependent upon the specific compositions and surfactants in question. The coefficients α, β, and γ may be positive, negative or zero, in different embodiments.

For example in one example the equation can be written as

$$y = - 0.0006 x \hat{} 2 + 0.3186 x + 18.619$$

indicating that when no surfactant is added, a predetermined quantity of the composition will fill 18.619% of the target on the card, and that with increasing levels of surfactant (i.e., increasing parts per million of the surfactant) the percentage of the target circle that is filled (i.e., the value of y) will increase, though the level of increase will taper off over time as the contribution from the second-order term begins to control.

For example in one embodiment the equation can be written as

$$y = - 0.0011 x \hat{} 2 + 0.4519 x + 24.255$$

indicating that when no surfactant is added, a predetermined quantity of the composition will fill 24.255% of the target on the card, and that with increasing levels of surfactant (i.e., increasing parts per million of the surfactant) the percentage of the target circle that is filled (i.e., the value of y) will increase, though the level of increase will taper off over time as the contribution from the second-order term begins to control.

It should be understood that the equations provided above only apply to situations where surface tension is a predominant force in the morphology of the test sample, such as for droplets (FIGS. 1-3C) or in capillary or wicking implementations (FIGS. 4A-4C) and similar implementations. In alternative examples, the equation can be relatively more or less complex. For example, in some examples there may be a linear relationship between the percent of the target of the substrate that is covered and the level of surfactant in the composition. On the other hand, there may be compositions where the level of surfactant causes third, fourth, or higher-order polynomial effects.

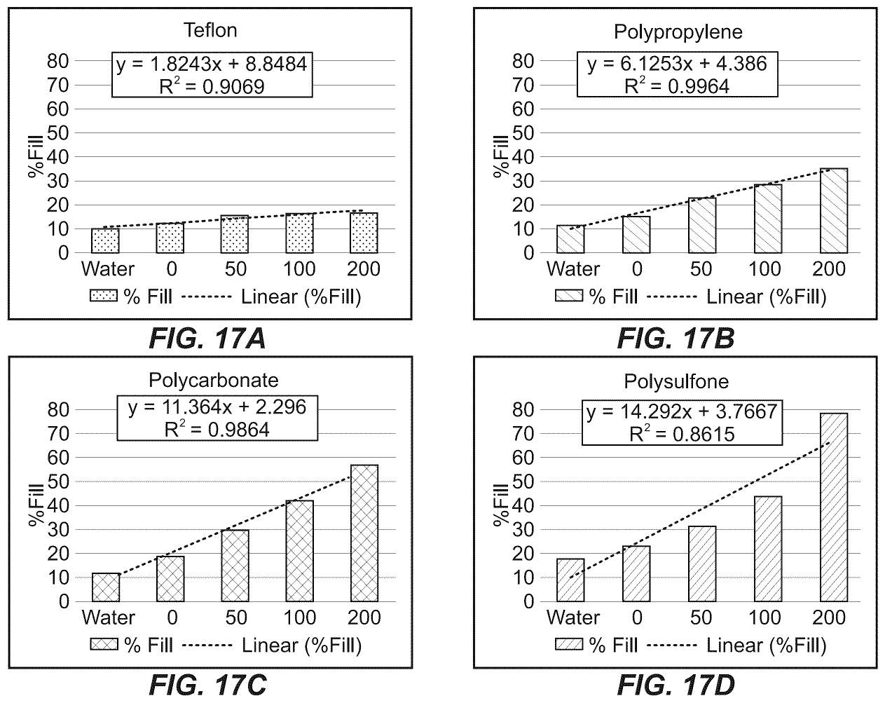

Some of the sources of surface tension described above, such as presence of complex molecules at the surface of a droplet, are variable even between droplets that have the same overall concentration. Thus it may be the case that different compositions or different surfactants may provide relatively better or worse levels of predictability. Built-in level of precision and confidence for a particular composition/surfactant pair is within the scope of this invention and is discussed in more detail below with respect to FIGS. 17A-17D.

Returning to the specific example of a second-order polynomial relationship between the percentage of the target filled and the surfactant concentration, the quadratic equation may be used to calculate the “positive” X value, which indicates the parts per million (ppm) value. The original droplet photo and scored droplet photo are saved and the data is returned to the mobile application. The data may include the HTTP, the ppm value, the percent filled, the storage URL, the original image of the scored substrate, the scored image of the substrate, or a visual indicator or color code indicating if the surfactant concentration is within a desired concentration range or too low or too high.

Once the mobile application receives the HTTP response, it may alert the user of successful scoring of the image and may display the detected ppm value, the original image, the scored image, the color code, or other visual indicator.

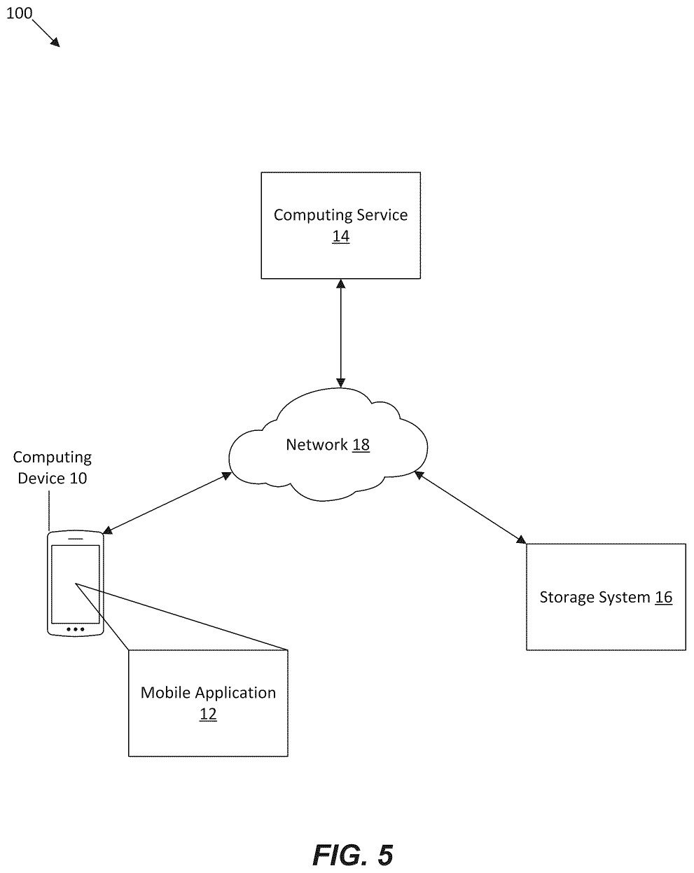

FIG. 5 illustrates an example network environment 100 in which aspects of the present disclosure may be implemented. In the example shown, the network environment 100 includes a computing device 10, a computing service 14, a storage system 16, and a network 18. The computing device 10 may include a mobile application 12. The environment 100 may include more or fewer components than those illustrated in the example of FIG. 5.

The computing device 10 may include hardware and software for performing certain operations described herein. In some examples, the computing device 10 may include one or more of the following components: a processor; memory, which may include RAM (Random Access Memory) and ROM (Read-Only Memory); an input/output system; a storage device that stores software instructions that may be executed by the processor, such as software instructions corresponding to the mobile application 12; a system bus; a network interface unit; a camera; and a display. In some examples, the computing device 10 is a combination of different computing devices. As examples, the computing device 10 may be a mobile phone, a tablet, a laptop, a desktop computer, an Internet of Things (IoT) device, a virtual reality headset, or another type of computing device.

The mobile application 12 may include software instructions for performing certain operations described herein. In some examples, the mobile application 12 is a native mobile application installed on the computing device 10. In some examples, the computing device 10 may download and install the mobile application 12 from a mobile application store. In some examples, the mobile application 12 may be a hybrid application or a web application.

The computing service 14 may include hardware and software for performing certain operations described herein. In some examples, the computing service 14 is a cloud-based computing service. In some examples, the computing service 14 may offer one or more of a Function-as-a-Service (FaaS), Software-as-a-Service (SaaS), Platform-as-a-Service (PaaS), or Infrastructure-as-a-Service (IaaS). In some examples, the computing service 14 provides a serverless environment in which functions associated with the mobile application 12 may be implemented. For example, the computing service 14 may perform backend processes for the mobile application 12. As such, functions and operations described herein as performed by a mobile application may, in some examples, be performed by the computing service 14. In some examples, the computing service 14 exposes one or more application programming interfaces (APIs) that may be called to perform functions, such as image analysis, implemented in the computing service 14. In some examples, the computing service 14 includes an HTTP endpoint. The computing service 14 and the storage system 16 may be remote from the computing device 10.

The storage system 16 may store data received from one or more of the mobile application 12 or the computing service 14. In some examples, the storage system 16 is a cloud-based storage system. In some examples, the storage system 16 implements object-based storage.

The network 18 may communicatively couple components of the network environment 100. The network 18 may be, for example, a wireless network, a wired network, a virtual network, the internet, another type of network, or a combination of networks.

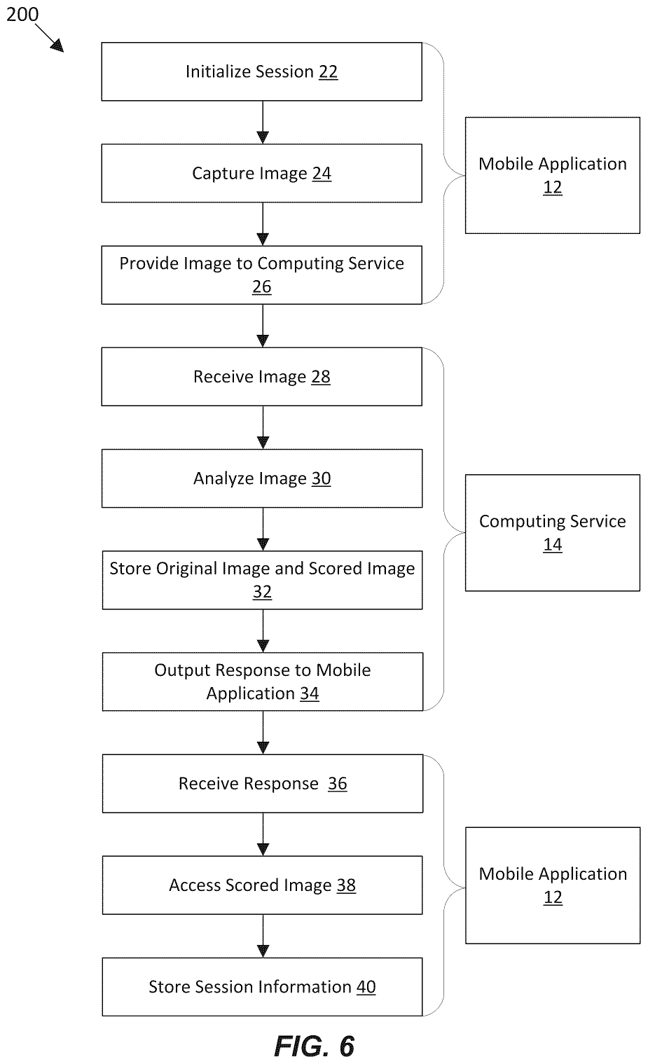

FIG. 6 is a flowchart of an example method 200 for performing example aspects of measuring a concentration of a surfactant in a composition. As shown by the example of FIG. 6, different components of the network environment 100 may perform different operations of the method 200. However, operations of the method 200 are not limited to being performed by the corresponding components depicted in in the example of FIG. 6. Moreover, the disclosed operations are described for purposes of illustrating the present technology and are not intended to limit the disclosure to a particular sequence of operations. For example, the operations can be performed in differing order, two or more operations can be performed concurrently, additional operations can be performed, operations can be repeated, and disclosed operations can be excluded without departing from the present disclosure. Further, each operation can be accomplished via one or more sub-operations.

At operation 22, the mobile application 12 may initialize a session. Initializing a session may include receiving or generating session information associated with an analysis to be performed. For example, session information may include data corresponding to a surfactant or substrate to be analyzed. As another example, session information may include metadata, such as a time, date, or information of a user conducting an analysis.

At operation 24, the mobile application 12 may capture an image. For example, the mobile application 12 may use a camera of the computing device 10 (shown in FIG. 5) to capture an image of a droplet of a surfactant-containing composition on a substrate.

At operation 26, the mobile application 12 may provide the image to the computing service 14. For example, the mobile application 12 may call an endpoint exposed by the computing service 14 and may request that the computing service 14 analyze the image. As part of the call to the endpoint exposed by the computing service 14, the mobile application 12 can provide the captured image and, in some examples, additional information corresponding to a session.

At operation 28, the computing service 14 may receive the image from the mobile application 12. The computing service 14 may also receive an instruction from the mobile application 12 to analyze the image and may also receive any additional information provided by the mobile application 12.

At operation 30, the computing service 14 may analyze the image, example aspects of which are described above. As part of analyzing the image, the computing service 14 may generate a scored image, which may include aspects of the original image and markings that correspond to edges of a surfactant-containing composition and a target circle. In some examples, analyzing the image may include performing one or more of the following operations: converting the original image from color to grayscale; reducing image noise, such as by performing Gaussian Blur; detecting circles in the image, such as by performing Circle Hough Transform; finding a target circle; drawing the target circle on the original image; cropping the original image to the diameter of the target circle; reducing noise in the cropped image, such as by performing Gaussian Blur; converting the cropped image from color to grayscale; creating a mask of the target circle and blacking out pixels not in the mask; performing edge detection on a circular region of interest, such as by using Canny Edge detection; performing morphological dilation on the edges; performing morphological closing on the dilated edges; finding and sorting contours of the edges; finding the largest contour (excluding the target spread circle) and calculating the area of the largest contour, which may correspond to the area of a droplet; draw a line on the image around the largest contour; find the area of the circular region of interest; calculate the percent of the droplet fill compared to the circular region of interest; use the percent value as y when solving for x in Equation 1 to derive the PPM value.

At operation 32, the computing service 14 may store the original image and the scored image in the storage system 16 (shown in FIG. 5).

At operation 34, the computing service 14 may output a response to the mobile application 12. The response may be an HTTP response. The response may indicate whether the computing service 14 successfully analyzed the image. In some examples, the response includes data generated by analyzing the image. For example, the response may include a PPM value and a percentage of the target circle filled by the droplet. In some examples, the response may include data for accessing the scored image. For example, the response may include a Uniform Resource Identifier (URI), such as Uniform Resource Locator (URL), that the mobile application 12 may use to access the scored image. In some examples, the computing service 14 may directly return the scored image to the mobile application 12.

At operation 36, the mobile application 12 may receive the response from the computing service 14.

At operation 38, the mobile application 12 may access the scored image. For example, the mobile application 12 may use a URL received from the computing service 14 to retrieve the scored image from the storage system 16. Furthermore, the mobile application 12 may display the scored image and data received from the computing service 14 on a screen of the computing device 10.

At operation 40, the mobile application 12 may store session information. For example, the mobile application 12 may provide session information associated with the analyzed image to the storage system 16. As such, the storage system 16 may store the scored image along with the session information associated with the scored image.

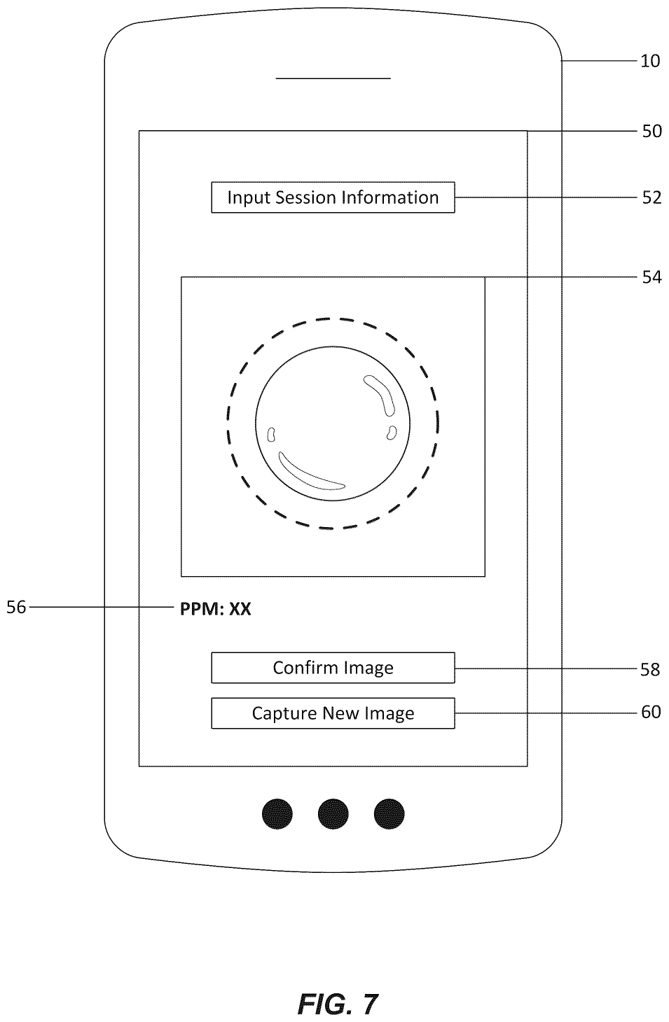

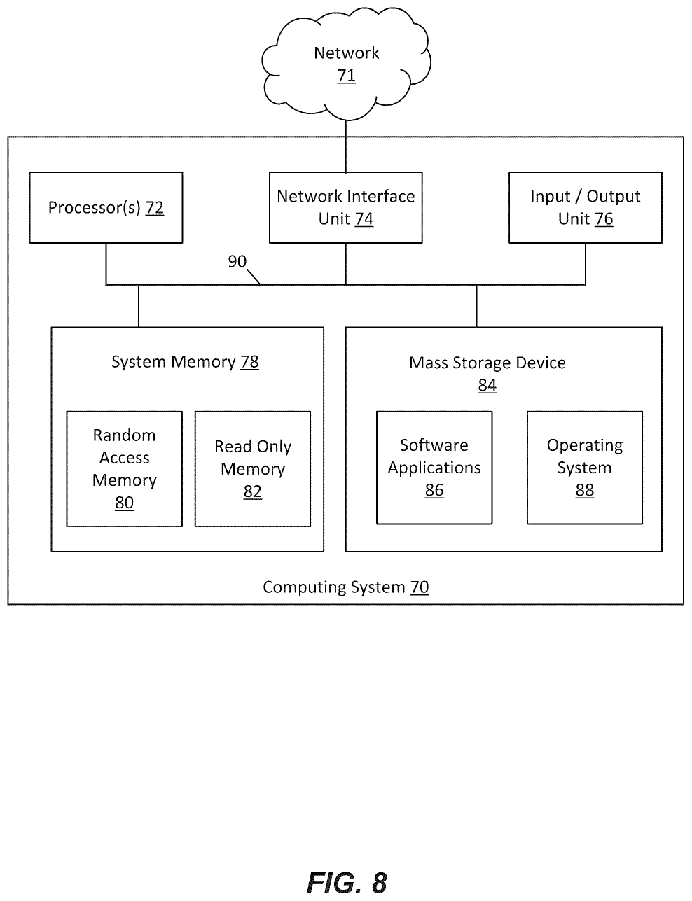

FIG. 7 illustrates an example user interface 50 of the mobile application 12. In the example shown, the user interface 50 is displayed on a screen of the computing device 10. As shown, the user interface 50 may include one or more display fields and one or more input fields. In the example of FIG. 7, the user interface 50 includes a session information input field 52, an image 54, a PPM 56, an image confirmation input field 58, and a capture new image input field 60. The user interface 50 may include more or fewer components that those illustrated in the example of FIG. 7.

The session information input field 52 may include one or more input fields via which the mobile application 12 may receive session information. In some examples, the session information input field 52 may include a text input field or an input field for selecting one or more analysis parameters.

The image 54 may be an original or scored image. In some examples, the image 54 includes each of the original and scored image of a test so that a user can compare the images. In some examples, the image 54 may include other visual data associated with a surfactant analysis.

The PPM 56 may be a display field that include a parts per million value determined when analyzing an image. In some examples, the PPM 56 corresponds to an analysis of the image 54.

The image confirmation input field 58 may be used by the mobile application 12 to receive a confirmation that the image 54 appears to be correctly analyzed. For example, a user may input a confirmation after determining that markings on the image correspond to edges of one or more of the droplet or target boundary. In response to receiving an image confirmation, the mobile application 12 may store session information.

The capture new image input field 60 may enable a user to capture a new image to be analyzed. For example, the mobile application 12 may capture a new image to perform a new analysis of a new droplet, or in response to receiving an error during an analysis of previous image.

FIG. 8 illustrates an example block diagram of a virtual or physical computing system 70. Aspects of the computing system 70 can be used to implement the system and processes described herein. For example, one or more of the computing device 10, the mobile application 12, the computing service 14, or the storage system 16 may be implemented using aspects of the computing system 70.

In the embodiment shown, the computing system 70 includes one or more processors 72, a system memory 78, and a system bus 90 that couples the system memory 78 to the one or more processors 72. The system memory 78 includes RAM 80 and ROM 82. A basic input/output system that contains the basic routines that help to transfer information between elements within the computing system 70, such as during startup, is stored in the ROM 82. The computing system 70 further includes a mass storage device 84. The mass storage device 84 is able to store software instructions and data. The one or more processors 72 can be one or more central processing units or other processors.

The mass storage device 84 is connected to the one or more processors 72 through a mass storage controller (not shown) connected to the system bus 90. The mass storage device 84 and its associated computer-readable data storage media provide non-volatile, non-transitory storage for the computing system 70. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 70.

According to various embodiments of the invention, the computing system 70 may operate in a networked environment using logical connections to remote network devices through the network 71. The network 71 may be the network 18 or may be communicatively coupled with the network 18. The network 71 is a computer network, such as an enterprise intranet and/or the Internet. The network 71 can include a LAN, a Wide Area Network (WAN), the internet, wireless transmission mediums, wired transmission mediums, other networks, and combinations thereof. The computing system 70 may connect to the network 71 through a network interface unit 74 connected to the system bus 90. It should be appreciated that the network interface unit 74 may also be utilized to connect to other types of networks and remote computing systems. The computing system 70 also includes an input/output controller 76 for receiving and processing input from a number of other devices, including a touch user interface display screen, or another type of input device. Similarly, the input/output controller 76 may provide output to a touch user interface display screen or other type of output device.

As mentioned briefly above, the mass storage device 84 and the RAM 80 of the computing system 70 can store software instructions and data. The software instructions include an operating system 88 suitable for controlling the operation of the computing system 70. The mass storage device 84 and/or the RAM 80 also store software instructions, that when executed by the one or more processors 72, cause one or more of the systems, devices, or components described herein to provide functionality described herein.

As described above, the methods for measuring the concentration of surfactant in a composition can be used with a test kit. In some examples, the test kit may comprise one or more substrates as described herein, and any of beakers, pipettes, eye droppers, rulers, calipers, instructions, and any other suitable components to measure surfactant concentration. In some examples, the methods and test kits described herein use one or more dyes that can be placed in samples to more clearly visualize the appearance and mobility of the sample on the substrate. In some examples, the test kit may include a preloaded mixing container with dye. In such examples, a user could fill the mixing container with the composition to be tested and shake to mix the dye with the composition for better visualization on the substrate. In other examples, the methods and test kits are free of dyes and rely solely on the properties of the compositions to measure surfactant concentration. In some examples, using dyes with the surfactant test kit interferes with proper spreading of the compositions.

As described herein, the methods and test kits can be used to measure surfactant concentration in any surfactant-containing composition, including cleaning compositions. Exemplary cleaning composition might be located in a sink, a bucket, a cleaning machine such as a surgical instrument cleaner, an automated endoscope reprocessor, or a clean-in-place (CIP) system. Exemplary CIP systems include a food and beverage CIP system or a corn ethanol plant. In such examples, the compositions and test kits and testing methods must be GRAS approved for animal feeds.

The specific formulation of the composition may impact the chemical properties of the composition and thus impact the substrate used to measure the surfactant concentration. However, the disclosure envisions that the surfactant concentration for any surfactant-containing composition can be measured provided that there is a standard for the composition to be tested. These standards can be developed in a laboratory setting, and substrates and/or mobile application programs associated with those compositions can be distributed to users.

When the method is used to test surfactant-containing compositions, the compositions to be tested using the methods and test kits described herein may include at least one surfactant. When the method is used to test for the absence of surfactants, the compositions tested may or may not include surfactants. The surfactants can be nonionic, anionic, cationic, amphoteric, zwitterionic, or combinations thereof. The methods and test kits described herein envision measurement of any type of surfactant. Examples of various surfactants are listed in a non-exhaustive list below.

### Nonionic Surfactants

In some embodiments, the surfactant comprises a nonionic surfactant. Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties.

Examples of suitable nonionic surfactants include alkyl-, aryl-, and arylalkyl-, alkoxylates, alkylpolyglycosides and their derivatives, amines and their derivatives, and amides and their derivatives. Additional useful nonionic surfactants include those having a polyalkylene oxide polymer as a portion of the surfactant molecule. Such nonionic surfactants include, for example, chlorine-, benzyl-, methyl-, ethyl-, propyl-, butyl- and other like alkyl-capped polyoxyethylene and/or polyoxypropylene glycol ethers of fatty alcohols; polyalkylene oxide free nonionics such as alkyl polyglycosides; sorbitan and sucrose esters and their ethoxylates; alkoxylated ethylene diamine; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and ethoxylated amines and ether amines and other like nonionic compounds. Silicone surfactants can also be used.

Examples of non-foaming, low foaming, or defoaming nonionic surfactants include block polyoxypropylene-polyoxyethylene polymeric compounds with hydrophobic blocks on the outside (ends) of the molecule, and nonionic surfactants modified by “capping” or “end blocking” terminal hydroxyl groups by reaction with a small hydrophobic molecule or by converting terminal hydroxyl groups to chloride groups. Other examples of non-foaming nonionic surfactants include alkylphenoxypolyethoxyalkanols; polyalkylene glycol condensates; defoaming nonionic surfactants having a general formula Z[(OR)nOH]z where Z is alkoxylatable material (e.g., an alkyl, alkyl alcohol, alkyl amine), R is a radical, n is 10-2,000, and z is determined by the number of reactive functional groups capable of reacting with oxygen; and conjugated polyoxyalkylene compounds.

In some examples, the nonionic surfactant is an alcohol alkoxylate with 8 to 18 carbon atoms. The alkoxylate is typically ethylene or propylene, or a combination thereof. In some embodiments, the alkoxylate has 2 to 10 moles of alkoxylation. Examples of a suitable commercially available alcohol alkoxylate surfactants include the PLURAFAC® line of surfactants from BASF, the TOMADOL surfactants, and the GENAPOL surfactants.

In some examples, the nonionic surfactant is a reverse block polymer. Reverse block copolymers which are block copolymers, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. Also included are di-functional reverse block copolymers (commercially available as PLURONIC® R from BASF Corp.) and tetra-functional reverse block copolymers (commercially available as TETRONIC® R from BASF Corp.)

### Anionic Surfactants

Exemplary anionic surfactants include carboxylic acids and their salts, such as alkanoic acids and alkanoates, ester carboxylic acids (e.g. alkyl succinates), ether carboxylic acids, and the like; phosphoric acid esters and their salts; sulfonic acids and their salts, such as isethionates, alkylaryl sulfonates, alkyl sulfonates, ester sulfonates, sulfosuccinates; and sulfuric acid esters and their salts, such as alkyl ether sulfates, alkyl sulfates, and the like.

Anionic surfactants include those with a negative charge on the hydrophilic group or surfactants in which the molecule carries no charge unless pH is elevated to neutrality or above (e.g. carboxylic acids). Carboxylate, sulfonate, sulfate, and phosphate are the polar (hydrophilic) solubilizing groups found in anionic surfactants. Of the cations (counter ions) associated with these polar groups, sodium, lithium, and potassium impart water solubility; ammonium and substituted ammonium ions provide both water and oil solubility; and calcium, barium, and magnesium promote oil solubility. The particular salts will be suitably selected depending upon the needs of the particular formulation. In some cases, lysine will act as the counter ion.

Examples of anionic surfactants also include linear and branched primary and secondary alkyl sulfates, alkyl ethoxysulfates, fatty oleyl glycerol sulfates, alkyl phenol ethylene oxide ether sulfates, the C5-C17 acyl-N—(C1-C4 alkyl) and —N—(C1-C2 hydroxyalkyl) glucamine sulfates, and sulfates of alkylpolysaccharides such as the sulfates of alkylpolyglucoside (the nonionic nonsulfated compounds being described herein).

Other examples of anionic surfactants include: ammonium and substituted ammonium (such as mono-, di- and triethanolamine) and alkali metal (such as sodium, lithium and potassium) salts of the alkyl mononuclear aromatic sulfonates such as the alkyl benzene sulfonates containing from 5 to 18 carbon atoms in the alkyl group in a straight or branched chain, e.g., the salts of alkyl benzene sulfonates or of alkyl toluene, xylene, cumene and phenol sulfonates; alkyl naphthalene sulfonate, diamyl naphthalene sulfonate, and dinonyl naphthalene sulfonate and alkoxylated derivatives.

Examples of anionic surfactants also include anionic carboxylate surfactants such as alkyl ethoxy carboxylates, the alkyl polyethoxy polycarboxylate surfactants and the soaps (e.g. alkyl carboxylates). Secondary soap surfactants (e.g. alkyl carboxyl surfactants) include those which contain a carboxyl unit connected to a secondary carbon. The secondary carbon can be in a ring structure, e.g. as in p-octyl benzoic acid, or as in alkyl-substituted cyclohexyl carboxylates. The secondary soap surfactants typically contain no ether linkages, no ester linkages, and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present.

Other anionic surfactants include olefin sulfonates, such as long chain alkene sulfonates, long chain hydroxyalkane sulfonates or mixtures of alkenesulfonates and hydroxyalkane-sulfonates. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). Resin acids and hydrogenated resin acids are also suitable, such as rosin, hydrogenated rosin, and resin acids and hydrogenated resin acids present in or derived from tallow oil.

### Cationic Surfactants

Cationic surfactants generally refer to compounds containing at least one long carbon chain hydrophobic group and at least one positively charged nitrogen. The long carbon chain group may be attached directly to the nitrogen atom by simple substitution; or indirectly by a bridging functional group or groups in so-called interrupted alkylamines and amido amines. Such functional groups can make the molecule more hydrophilic or more water dispersible, more easily water solubilized by co-surfactant mixtures, or water soluble. For increased water solubility, additional primary, secondary or tertiary amino groups can be introduced, or the amino nitrogen can be quarternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

A commonly used group of cationic surfactants is amines, such as alkylamines and amido amines. The composition may comprise cationic surfactants, selected either from the amino group, or from other cationic surfactants. The amine group includes, for example, alkylamines and their salts, alkyl imidazolines, ethoxylated amines, and quaternary ammonium compounds and their salts. Other cationic surfactants include sulfur (sulfonium) and phosphorus (phosphonium) based compounds that are analogous to the amine compounds.

### Amphoteric and Zwitterionic Surfactants

Amphoteric and zwitterionic surfactants include derivatives of secondary and tertiary amines, derivatives of heterocyclic secondary and tertiary amines, or derivatives of quaternary ammonium, quaternary phosphonium or tertiary sulfonium compounds. The ammonium, phosphonium, or sulfonium compounds can be substituted with aliphatic substituents, e.g., alkyl, alkenyl, or hydroxyalkyl; alkylene or hydroxy alkylene; or carboxylate, sulfonate, sulfate, phosphonate, or phosphate groups. Betaine and sultaine surfactants are examples zwitterionic surfactants.

Zwitterionic surfactants can be thought of as a subset of amphoteric surfactants. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion, a negative charged carboxyl, sulfate, or sulfonate group, and an alkyl group. Zwitterionics generally contain cationic and anionic groups which ionize to a nearly equal degree in the isoelectric region of the molecule, and which can develop strong “inner-salt” attraction between positive-negative charge centers.

Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate. Betaine and sultaine surfactants are exemplary zwitterionic surfactants. In some examples, the composition may include additional materials such as carbonate, bicarbonate, detergents, chelating agents, builders, thickeners, solvents, sanitizers or antimicrobial agents, preservatives, corrosion inhibitors, anti-redeposition agents, or other functional ingredients. In some embodiments, additional materials are selected to be compatible with feed additives or are considered food grade or generally recognized as safe.

Amphoteric or ampholytic surfactants contain both a basic and an acidic hydrophilic group and an organic hydrophobic group. These ionic entities may be any of the anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate, or phosphate provide the negative charge.

Amphoteric surfactants can be broadly described as derivatives of aliphatic secondary and tertiary amines, in which the aliphatic radical may be straight chain or branched and wherein one of the aliphatic substituents contains from 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia,” Cosmetics & Toiletries, Vol. 104 (2) 69-71 (1989). The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation, for example with ethyl acetate. During alkylation, one or two carboxy-alkyl groups react to form a tertiary amine and an ether linkage with differing alkylating agents yielding different tertiary amines.

Examples of commercially available imidazoline-derived amphoterics include: cocoamphopropionate, cocoamphocarboxy-propionate, cocoamphoglycinate, cocoamphocarboxy-glycinate, cocoamphopropyl-sulfonate, and cocoamphocarboxy-propionic acid. Preferred amphocarboxylic acids are produced from fatty imidazolines in which the dicarboxylic acid functionality of the amphodicarboxylic acid is diacetic acid and/or dipropionic acid. The carboxymethylated compounds (glycinates) described here are frequently called betaines.

As described above, the methods and test kits described herein can be used to test any surfactant-containing composition to measure the concentration or detect the presence of surfactant. In some examples, the surfactants can be used alone or in compositions consisting only of other surfactants. These surfactants or mixtures of surfactants may be added to other materials. In some examples, the surfactants may be part of a formulated product that comprises additional materials. The formulated product may be a concentrate that must be diluted before use in the relevant application, or the formulated product may be a ready-to-use (RTU) product.

Such mixtures and formulated products may have varying pH levels depending on the application of the product. For example, a formulated product or mixture or composition may have an acidic pH, an alkaline pH, or a neutral pH depending on the use of the surfactant-containing product or mixture. In some examples, the mixture, formulated product, or composition has a pH of about 1, about 2, about 3, about 4, about 5, about 6, about 7, about 8, about 9, about 10, about 11, about 12, about 13, or about 14. In some examples, the pH is from 1 to about 7. In some examples, the pH is from about 1 to about 4. In some examples, the pH is from about 7 to about 14. In some examples, the pH if from about 5 to about 8. In some examples, the pH is from about 8 to about 14. All pH values from 1-14 and any ranges within are contemplated by the disclosure.

Various acid and alkaline sources can be included to impart the desired pH. Exemplary alkalinity sources include alkali metal hydroxide, alkali metal carbonate, and alkali metal bicarbonates. Exemplary acid sources include organic acids and mineral acids. Acid sources refer to compounds that can introduce H+ ions into a solution, which lowers the pH of the solution. Alkalinity sources refer to compounds that introduce OH-ions into a solution. The OH-ions react with H+ ions to raise the pH. Acid or alkaline sources may be added to any of the compositions disclosed herein to raise or lower the pH. For example, a composition to be tested for the presence or absence of surfactant may be very acidic, however, the substrate to test the concentration may be designed to test compositions with a neutral pH. An alkalinity source may be added to the composition to raise the pH to neutral. As another example, in a composition comprising an anionic surfactant, the surfactant may carry a charge. Acid sources or alkalinity sources may be added to the composition to regulate the pH so that it interacts as expected with a hydrophobic substrate.

Any such surfactant-containing product described herein may be in the form of a liquid, an emulsion, a solution, a solid, or any other formulation. In such products, the surfactant may be combined with numerous additional ingredients to achieve the desired cleaning properties of any composition. Non-limiting examples of additional ingredients that may impact the cleaning properties of a composition are described below.

### Builders

The surfactant-containing compositions may optionally include one or more builders. Builders include chelating agents (chelators), sequestering agents (sequestrants), detergents, and the like. Builders can be used to stabilize the composition or solution. Examples of suitable builders include phosphonic acids and phosphonates, phosphates, aminocarboxylates and their derivatives, pyrophosphates, polyphosphates, ethylenediamine and ethylenetriamine derivatives, hydroxyacids, and mono-, di-, and tri-carboxylates and their corresponding acids. Still other builders include aminocarboxylates, including salts of N,N-dicarboxymethyl glutamic acid (GLDA), methylglycinediacetic acid (MGDA), ethylenediaminetetraacetic acid (EDTA), hydroxyethylenediaminetetraacetic acid (HEDTA), and diethylenetriaininepentaacetic acid. Preferred builders are water soluble. Particularly preferred builders include EDTA (including tetra sodium EDTA), TKPP (tripotassium polyphosphate), PAA (polyacrylic acid) and its salts, polyacrylic/polymaleic acid and its salts, and sodium gluconate.

### Solvents

The surfactant-containing compositions may optionally include one or more organic solvents. Suitable solvents include organic solvents, such as, esters, ethers, ketones, amines, mineral spirits, aromatic solvents, non-aromatic solvents, and nitrated and chlorinated hydrocarbons. Preferred solvents include water soluble materials like glycerin, propylene glycol, urea, ethanol, propanol, butanol, short chain fatty acids, ethanol, and amines.

### Sanitizers, Antimicrobial Agents, and Preservatives

The surfactant-containing compositions may optionally include a sanitizer, antimicrobial agent, or preservative. Suitable sanitizers, antimicrobials, and preservatives include fatty acids, organic acids, anionic surfactants, iodine-based sanitizers, quaternary ammonium compounds, chlorine dioxide, acidified sodium chlorite, hydrogen peroxide, and organic peroxides.

### Corrosion Inhibitors

The surfactant-containing compositions may optionally include a corrosion inhibitor. The equipment in industrial facilities is typically made from stainless steel and subject to corrosion. Examples of suitable corrosion inhibitors include quaternary ammonium salts, betaines, pyridine, pyridine carboxylic acids, C12 to C18 fatty acids (saturated and unsaturated), fatty acid esters, sugar esters, tannic acid and salts, polyphosphoric acid and salts thereof, phosphoric acid and salts thereof, phospholipids, phosphate ester, carboxylic acids, tocopherol, polygalacturonic acid (pectic acid), alkyl alcohol ethoxylates.

### Anti-Redeposition Agents

The surfactant-containing composition may optionally include an anti-redeposition agent capable of facilitating sustained suspension of soils in a cleaning solution and preventing the removed soils from being redeposited onto the equipment being cleaned. Examples of suitable anti-redeposition agents include fatty acid amides, complex phosphate esters, polyvinyl alcohol, polyethylene glycol, xanthan gum, and cellulosic derivatives such as hydroxyethyl cellulose, hydroxypropyl cellulose, hydroxymethylcellulose, and the like.

The following non-limiting examples are provided as illustrative embodiments. Notwithstanding that the numerical ranges and parameters are approximations, the numerical values set forth in the specific examples are reported as precisely as possible. Any numerical values, however, inherently contain certain errors necessarily resulting from the standard deviation found in their respective testing measurements. The examples are illustrative and may only show limited numerical quantities of the components described above. Only some examples are shown for the sake of brevity, but the full quantity ranges of components described above are contemplated.

### EXAMPLES

### Example 1: Evaluation of Surfactant on Spread on Filter Paper

Two alkaline solutions were prepared, one with surfactant and one without surfactant. The surfactant used for this Example was Plurafac® RA 300 made by BASF Corporation. The contents of the solutions are shown in Table 1 below.

TABLE 1
Preparation of alkaline solutions with and without surfactant

| | Formula 1 | Formula 2 |
|---|---|---|
| | Quantity | Quantity |
| Component | (wt. %) | (wt. %) |
| Water | 97.955 | 97.71 |
| Carbonate | 1 | 1 |
| Bicarbonate | 1 | 1 |
| Thickener | 0.02 | 0.02 |
| EDTA | 0.025 | 0.25 |
| Plurafac ® RA300 | 0 | 0.02 |

In Trial 1, a standard lab pipette was used to drop approximately 1 drop of Formula 1, Formula 2, and a water control onto a Whatman Filter Paper #4 (90 mm, Cat No. 1007090). A timer was started for 1 minute, and after 1 minute, a caliper was used to measure the diameter of the spread drop on the filter paper, which is shown in Table 2.

TABLE 2
Diameter of drops from a standard lab pipette in Trial 1

| | Time between drop and | Diameter of spread |
|---|---|---|
| Solution | measurement (minutes) | drop (inches) |
| Formula 1, sample 1 | 1 | 0.946 |
| Formula 1, sample 2 | 1 | 0.873 |
| Formula 2 | 1 | 0.888 |
| Water | 1 | 0.855 |

Using a standard lab pipette did not produce drops of equal quantity because the lower surface tension of the surfactant-containing Formula 2 resulted in a drop that fell quicker and with less liquid as compared to Formula 1 and water that do not include surfactant. Therefore, the diameter measurements are impacted by the amount of solution that was dropped onto the filter paper.

The experiment was repeated in Trial 2, and an automatic micropipette was used to deliver exactly 50 μl of each solution to the filter paper. After 1 minute, a caliper was used to measure the diameter of the spread drop on the filter paper, which is shown in Table 3. Formula 2 containing surfactant demonstrated a slightly larger spread of the drop.

TABLE 3
Diameter of drops from 50 μl from automatic pipette in Trial 2

| | Time between drop and | Diameter of spread |
|---|---|---|
| Solution | measurement (minutes) | drop (inches) |
| Formula 1 | 1 | 1.125 × 1.087 |
| Formula 2 | 1 | 1.147 × 1.087 |
| Water | 1 | 1.138 × 1.08 |

The steps of Trial 2 were repeated in Trial 3, but the filter paper was placed on top of a polypropylene coupon with low surface energy. After 1 minute, the diameter of the drop spread was measured, as shown in Table 4.

TABLE 4
Diameter of drops from 50 μl from automatic pipette in Trial 3

| | Time between drop and | Diameter of spread |
|---|---|---|
| Solution | measurement (minutes) | drop (inches) |
| Formula 2 | 1 | 1.115 × 1.121 |
| Water | 1 | 1.195 × 1.082 |

### Example 2: Evaluation of Surfactant Spread on Polypropylene Coupon

Three solutions were prepared in accordance with Table 5 below.

TABLE 5
Preparation of solutions with varying amounts of surfactant

| | Formula 1 | Formula 2 | Formula 3 |
|---|---|---|---|
| | Quantity | Quantity | Quantity |
| Component | (wt. %) | (wt. %) | (wt. %) |
| Water | 97.955 | 97.71 | 97.72 |
| Carbonate | 1 | 1 | 1 |
| Bicarbonate | 1 | 1 | 1 |
| Thickener | 0.02 | 0.02 | 0.02 |
| EDTA | 0.025 | 0.25 | 0.25 |
| Plurafac ® RA300 | 0 | 0.02 (=200 ppm) | 0.01 (=100 ppm) |

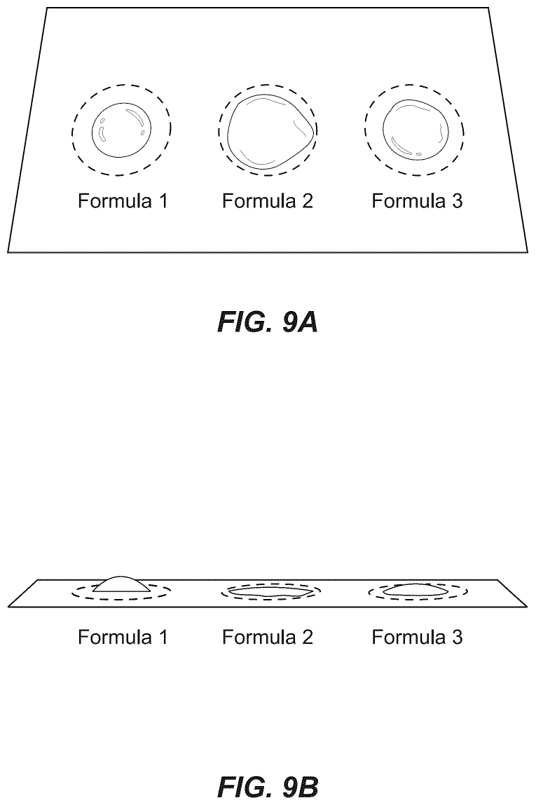

One drop of each formula was dropped onto a polypropylene coupon using a standard lab pipette. The spread and beading of each drop was observed and is shown in FIGS. 9A and 9B. In FIGS. 9A-9B, the drop of Formula 1, with no surfactant, is shown as a bead of liquid that has minimal spreading. The drop of Formula 2, which includes 200 ppm of surfactant, has spread considerably due to the lowered surface tension of the surfactant. The drop of Formula 3, which includes 100 ppm of surfactant, has spread more than Formula 1 due to the presence of surfactant but less than Formula 2 because it contains a lower concentration of surfactant.

Three 0.6-inch diameter circles were drawn with a sharpie on a polypropylene coupon. Three drops of Formula 1 were placed into the first circle, three drops of Formula 3 were placed in the second circle, and three drops of Formula 2 were placed in the third circle. The distance that the solutions traveled within the circle was measured as an indicator of surfactant concentration.

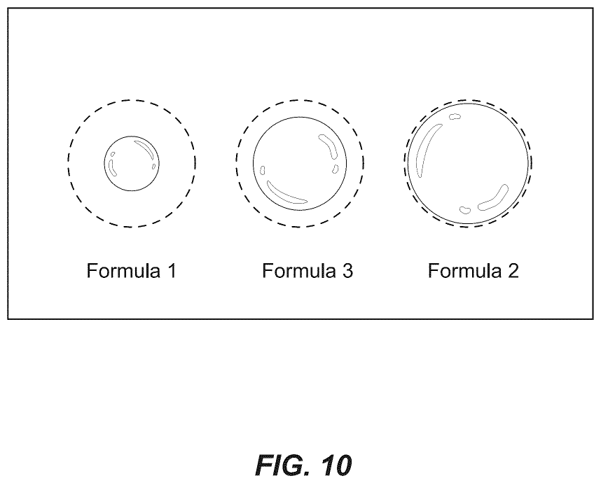

FIG. 10 shows the spread of all three samples on the polypropylene coupon. Solutions with higher surfactant concentration will spread farther and reach closer to the edges of the circle, as shown with the third circle with Formula 2 that has the highest surfactant concentration. Formula 1 in the first circle beaded on the polypropylene coupon because there is no surfactant in Formula 1.

### Example 3: Evaluation of Surfactant Spread on Absorbent Cloth

A WYPALL® cloth was used as the absorbent cloth in evaluating the spread of surfactant. A WYPALL® cloth is a non-woven material typically in the form of disposable dry wipes or cloths that are absorbent. A piece of WYPALL® cloth was cut into two equal strips and a dot was placed at the top of each strip at an equidistant location on both strips. The first strip was dipped in Formula 1, and the solution traveled up the WYPALL® cloth and reached the dot at 60 seconds. The second strip was dipped in Formula 3, and the solution traveled up the WYPALL® cloth and reached the dot at 34 seconds. The formula including surfactant traveled up the WYPALL® cloth almost twice as fast as the solution without surfactant.

### Example 4: Evaluation of Surfactant Spread in Compositions with Mash

Several cleaning compositions were tested, with and without surfactant and mash. On a 2×6 inch polypropylene coupon, nine 0.6-inch diameter circles were drawn for solution drops to be placed in. 50 μl of each sample was added using a micropipette to each circle. The samples are identified in Table 6. Field Sample A and Field Sample B were taken from a field setting with a surfactant-containing solution. The concentration of surfactant in Field Samples A and B was not known prior to testing, and the samples were used for comparison purposes.

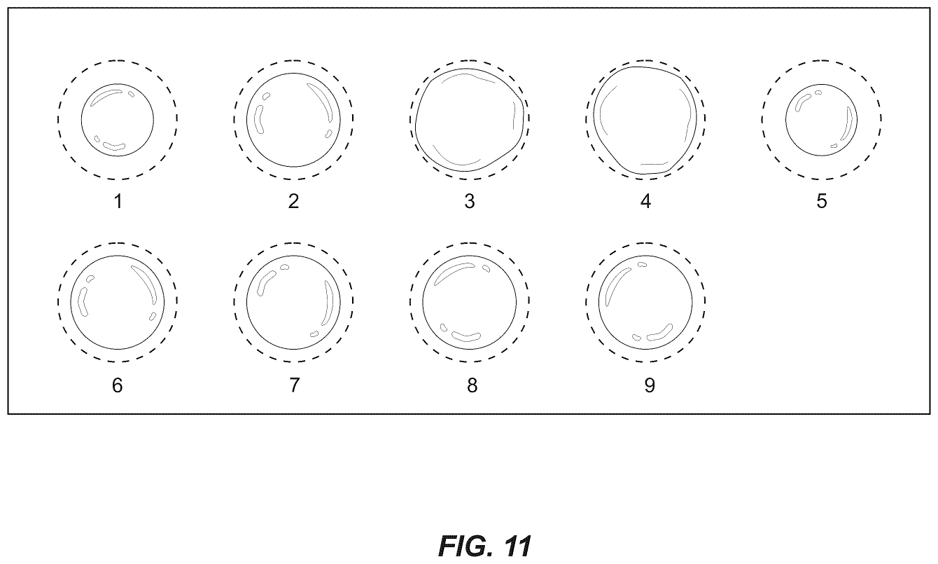

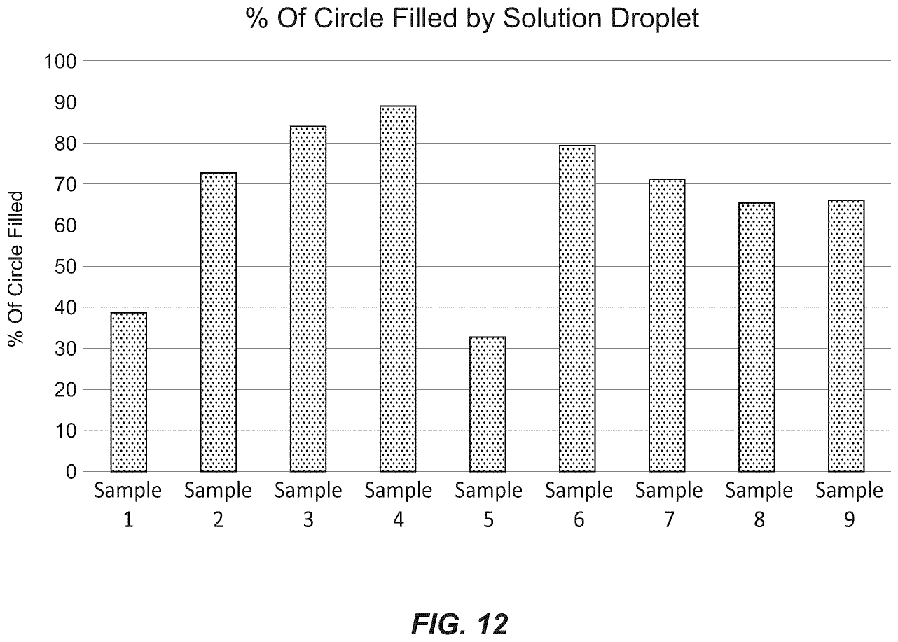

FIG. 11 shows the spread of each sample on the polypropylene coupon within each circle. An image of each sample spread was analyzed using Image J to determine pixel size of the droplets in relation to total pixels of the circle, which measured the area of spread of the droplets. Table 6 shows the pixels and percent area of the 0.6-inch diameter circle that each droplet occupied. FIG. 12 shows a graphical representation of the data from Table 6.

TABLE 6
Samples with and without surfactant and mash

| Sample # | Contents of Sample | Pixels | % area of circle |
|---|---|---|---|
| 1 | Formula 1 | 5791 | 38.69955 |
| 2 | Formula 2 | 10960 | 73.24245 |
| 3 | Field Sample A | 12653 | 84.55627 |
| 4 | Field Sample B | 13376 | 89.38786 |
| 5 | Formula 1 + 1% mash | 4877 | 32.59155 |
| 6 | Formula 2 + 1% mash | 11932 | 79.73804 |
| 7 | 50/50 mix of Formula 1 + | 10692 | 71.45148 |
| | Formula 2 | | |
| 8 | 50/50 mix of Formula 1 + | 9863 | 65.91152 |
| | Formula 2, + 1% mash | | |
| 9 | 50/50 mix of Formula 1 + | 9940 | 66.42609 |
| | Formula 2 (repeat of sample | | |
| | 7) | | |

Samples 3 and 4, the two field samples, spread the most and occupied the greatest area of the circle. Samples that include surfactant, with or without mash, have a higher percentage of the circle filled as compared to Samples 1 and 5 that have no surfactant, which is expected given that surfactants cause greater spread due to decreased surface tension.

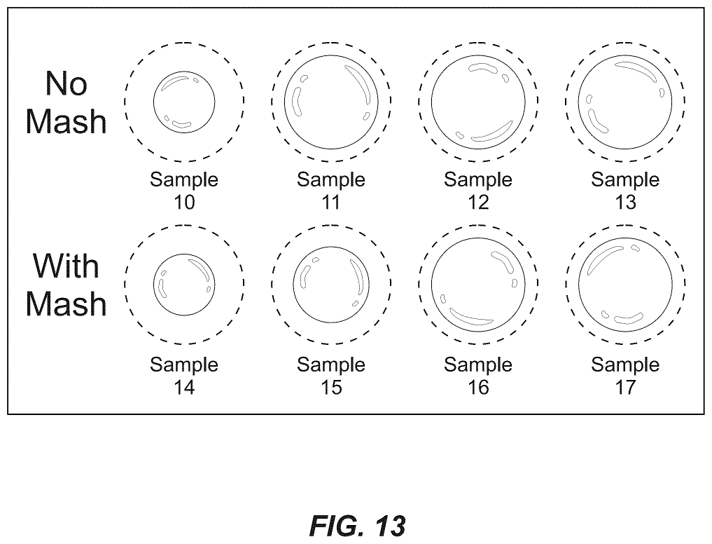

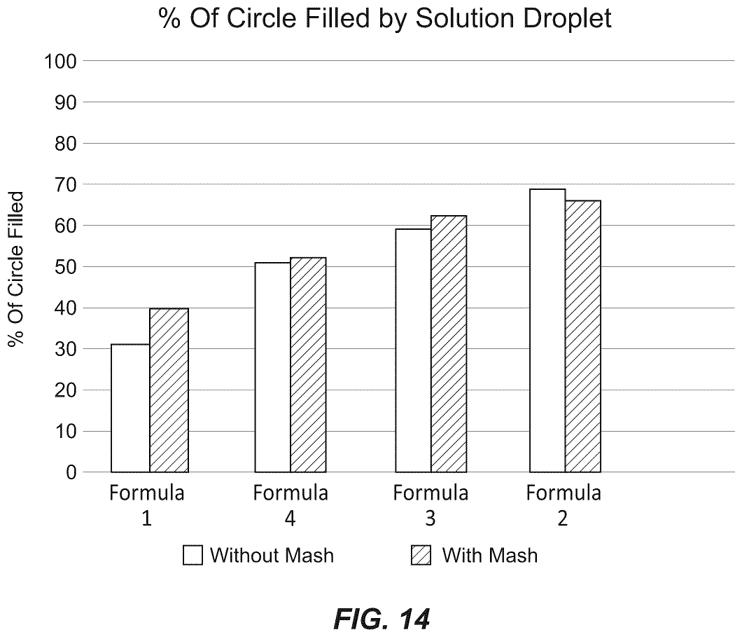

Another trial was performed to compare the spread of droplets with and without mash. In this trial, Formula 4 was introduced, which comprised 50 ppm of surfactant. The remaining components of Formula 4 were the same as Formula 3 except the water content was 97.725 wt. %. Table 7 shows the results of the trial with the percent area of the test circle that was filled by each drop. FIG. 13 shows the spread of the droplets, and FIG. 14 shows a graphical representation of the results. The results show that mash did not significantly impact the spread of the solution. There is a distinctive difference between the spread of solutions with low or no surfactant concentration compared to higher surfactant concentration.

TABLE 7
Impact of mash on surfactant spread

| Sample # | Contents of Sample | Pixels | % area of circle |
|---|---|---|---|
| 10 | Formula 1 | 4368 | 30.97872 |
| 11 | Formula 4 | 7166 | 50.8227 |
| 12 | Formula 3 | 8328 | 59.06383 |
| 13 | Formula 2 | 9689 | 68.71631 |
| 14 | Formula 1 + 1% mash | 4420 | 39.71963 |
| 15 | Formula 4 + 1% mash | 5783 | 51.96801 |
| 16 | Formula 3 + 1% mash | 6928 | 62.25737 |
| 17 | Formula 2 + 1% mash | 7296 | 65.56434 |

### Example 5: Compatibility of Surfactant and Substrate

A concentrate composition comprising a nonionic alcohol alkoxylate surfactant (Plurafac® SLF 180 produced by BASF Corporation) was prepared in accordance with Table 8. The dyes listed in Table 8 were added for the purpose of visually the spread of droplets for this Example. The concentration of the surfactant was measured as described herein based on 1) spread of the surfactant on a polypropylene coupon, 2) distance traveled on a strip, and 3) distance traveled on an absorbent cloth.

TABLE 8
Concentrate composition formula

| Component | Quantity (wt. %) |
|---|---|
| Water | 80.595 |
| C10-C16 alcohol alkoxylate | 0.75 |
| Isotridecyl Alcohol 6 mol Ethoxylate | 0.75 |
| Plurafac ® SLF 180 | 3.5 |
| Sodium Xylene Sulfonate (40%) | 14 |
| Phosphonic acid (60%) | 0.4 |
| FD&C Blue 1 | 0.0017 |
| FD&C Yellow 5 | 0.0033 |

Six stepwise dilutions were prepared using the concentrate composition in concentrations of 250 ppm, 500 ppm, 750 ppm, 1000 ppm, 1500 ppm, and 1750 ppm of Plurafac® SLF 180.

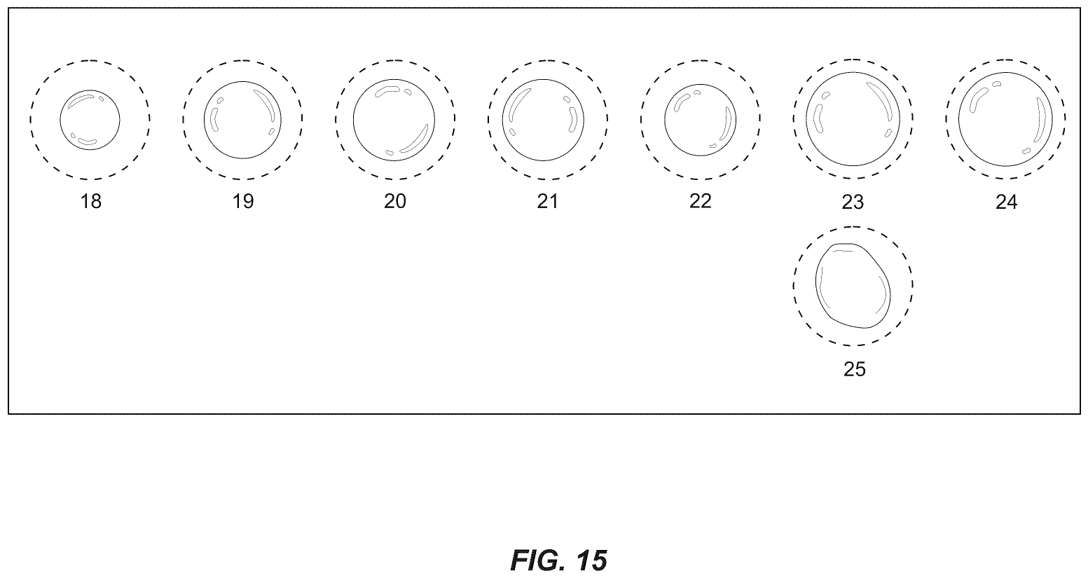

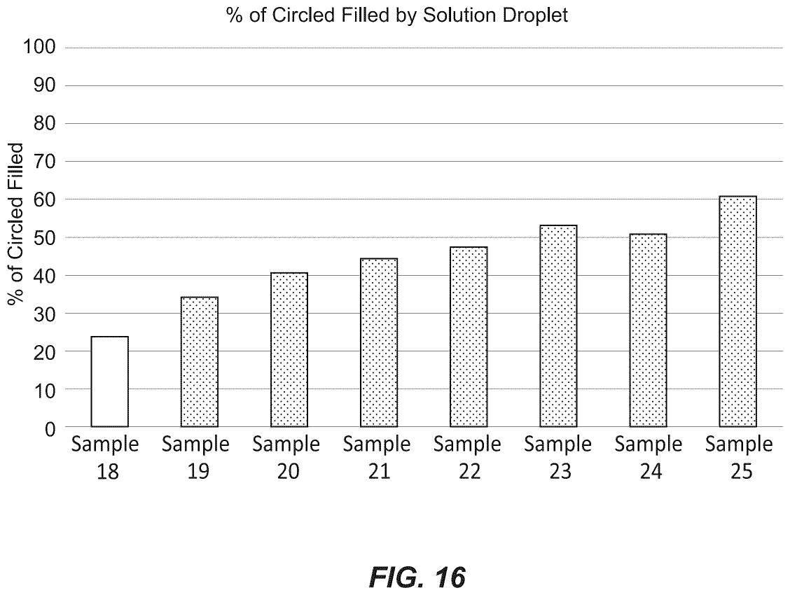

Eight 0.6 inch diameter circles were drawn on a polypropylene coupon. 50 μL of each of the six dilutions was placed in six of the circles using a micropipette. 50 μL of water was placed in one circle as a control, and 50 μL of the concentrate composition was placed in another circle. The spread of the droplets in each of the eight circles was observed and measured using Image J analysis. Table 9 shows the results of the trial with the % area of circle that the composition spread to cover. FIG. 15 shows a visual representation of the spread of each droplet, and FIG. 16 shows a graphical representation of the results.

TABLE 9
Impact of concentration on droplet spread

| Sample # | Contents of Sample | Pixels | % area of circle |
|---|---|---|---|
| 18 | Water | 957 | 23.50774 |
| 19 | 250 ppm Plurafac ® SLF 180 | 1396 | 34.29133 |
| 20 | 500 ppm Plurafac ® SLF 180 | 1663 | 40.84991 |
| 21 | 750 ppm Plurafac ® SLF 180 | 1807 | 44.38713 |
| 22 | 1000 ppm Plurafac ® SLF 180 | 1930 | 47.4085 |
| 23 | 1500 ppm Plurafac ® SLF 180 | 2166 | 53.2056 |
| 24 | 1750 ppm Plurafac ® SLF 180 | 2078 | 51.04397 |
| 25 | Concentrate composition | 2959 | 60.67254 |

Despite the stepwise increase in concentration of surfactant, the spread of the droplets across the concentration range changed minimally. A concentration of 250 ppm of surfactant resulted in 34.29133% of the circle being filled, while a concentration of 1750 ppm of surfactant resulted in only 51.043097% of the circle being filled. Even the undiluted concentrate composition only filled about 60% of the circle.

This is also shown in FIGS. 15 and 16, in which the visible size of the droplet increased only slightly with increased concentration. As a result, the slope of the concentration increase (as shown in FIG. 16) is minimal. This suggests an incompatibility between the substrate and the surfactant. In order to measure surfactant concentration as described herein, the substrate and the surfactant must be compatible such that increasing surfactant concentration in the composition results in a continually increasing spread of the composition on the substrate (or continually decreasing spread of the composition depending on the surfactant and substrate combination). When the change in spread for increasing concentrations is minimal, as demonstrated in this Example, it is challenging to evaluate if the surfactant concentration is correct because the spread of droplets across the concentration ranges is similar and none of the circles reach the target circle spread.

The same eight samples (i.e., the six diluted concentrate samples, the water sample, and the concentrate sample) were tested on filter paper strips and absorbent cloth, as described in the method in Example 3. The results were similar with the strips and the absorbent cloth-increasing the concentration of surfactant did not result in a linear increase in distance traveled on the strips or absorbent cloth, nor did the travel time up the strips and absorbent cloth show any linear increase with increasing concentration. This further suggests that Plurafac® SLF 180 was not compatible with these substrates and thus the surfactant concentration could not be accurately measured with these substrates for this particular surfactant.

The surface tension for each of the eight samples was measured using a bubble tensiometer and the Wilhelmy Plate method. Minimal changes in surface tension across the concentration range were measured, suggesting that the surfactant composition was being tested around its CMC for the tested substrates. Additional testing would need to be performed to optimize surfactant concentration measurement for Plurafac® SLF 180, perhaps with different dilutions and/or with different substrate(s).

### Example 6: Comparing Surfaces with a Surfactant

A surfactant-containing composition was tested on four surfaces (Teflon, polypropylene, polycarbonate, and polysulfone) to compare the compatibility of each surface with a particular surfactant.

Two formulas were prepared in accordance with Table 10, one without surfactant (Formula 1) and one with surfactant (Formula 2)

TABLE 10
Preparation of alkaline solutions with and without surfactant

| | Formula 1 Quantity | Formula 2 Quantity |
|---|---|---|
| Component | (wt. %) | (wt. %) |
| Water | 97.955 | 97.71 |
| Carbonate | 1 | 1 |
| Bicarbonate | 1 | 1 |
| Thickener | 0.02 | 0.02 |
| EDTA | 0.025 | 0.25 |
| Plurafac ® RA 300 | 0 | 0.02 |

Two additional concentrations were prepared by diluting Formula 2 to form samples with concentrations of 50 ppm and 100 ppm surfactant. Therefore, four concentrations were tested on each surface: 0 ppm surfactant (i.e., Formula 1), 50 ppm, 100 ppm, and 200 ppm (i.e., Formula 2). 200 μL of each sample was placed inside a 3 cm circle drawn on each of Teflon, polypropylene, polycarbonate, and polysulfone. A water sample was also tested for each surface as a control. The % fill of each circle was measured in accordance with the methods described herein. The % fill may correspond to a spread of the surfactant relative to a standard, such as a target circle. The % fill for each surface with the increasing concentrations of surfactant are shown in FIGS. 17A-D.

A regression line and corresponding equation are shown for FIGS. 17A-17D. The regression line includes surfactant concentration as the independent variable (shown on the x-axis) and % fill as the dependent variable (shown on the y-axis). Each regression line includes a slope (the number immediately preceding the “x” in the equations of FIGS. 17A-17D) that corresponds to the change of % fill due to a change in surfactant concentration.

As discussed above with respect to FIG. 6, the relationship between the concentration of surfactant and the composition can be linear, or it can take the form of a higher-order polynomial. In the example shown in FIGS. 17A-17D, the relationship is linear. The percentage fill (i.e., y of Equation 1) is shown on the y axis, while the concentration of surfactant is shown in parts per million along the x axis. As shown by the differences between the fill percentages y between FIGS. 17A-17D, the composition of the substrate, which affects surface tension, also has a significant effect on the wetting of the droplet on the substrate, with low surface-energy materials such as Teflon (FIG. 17A) exhibiting significantly lower fill percentage y than polycarbonate or polysulfone (FIGS. 17C and 17D, respectively), with polypropylene (FIG. 17B) in between the two.

Additionally, as shown in the contrast between FIGS. 17C and 17D, there can be different levels of precision in the results depending on the surfactant, the composition, and the substrate material. The relatively low coefficient of determination (commonly referred to as an R² value) in FIG. 17D indicates that there is relatively low precision when using that substrate when compared to FIG. 17C. This indicates that polycarbonate may be a more precise substrate for use in measurement of surfactant concentration in this particular example (with this particular surfactant-containing composition) than polysulfone.

There can be multiple reasons for precision to vary between different substrate materials, surfactants, and compositions. In this example, polysulfone (FIG. 17D) may be exhibiting a second- or third-order polynomial response in percent fill while polycarbonate exhibits only a linear relationship. To determine the appropriate order, the surfactant and composition can be modeled theoretically for a particular substrate. Alternatively, if the data follows a curvilinear pattern as in FIG. 17D, a higher-degree polynomial may be tried to determine whether this results in a higher coefficient of determination. However, overfitting the data may occur when a high-degree polynomial is used to fit noise or random variations instead of the underlying pattern, and overfitting can lead to poor generalization and inaccurate predictions. Therefore it may be more appropriate to select an easily-modeled substrate than to add complexity to the modeling equation (e.g., Equation 1) by adding higher-order components.

To determine polynomial order, one can use techniques such as visual inspection, analyzing the residuals, or applying statistical tests. Visual inspection involves plotting the data with different polynomial fit lines and selecting the order that best captures the underlying pattern without excessive fluctuations. Analyzing the residuals, which are the differences between the observed and predicted values, can help identify the order that minimizes these differences. Additionally, statistical tests such as the Akaike Information Criterion (AIC) or Bayesian Information Criterion (BIC) can provide quantitative measures to compare different polynomial models and identify the most appropriate one.

When performing a fit analysis on a multivariate dataset (i.e., fill percentage based on the composition, the surfactant, the substrate composition and flatness, and the concentration of the surfactant), a higher coefficient of determination implies that the independent variables used in the model collectively have a stronger influence on the dependent variable. This indicates that the relationship between the variables is more significant and can be modeled more accurately. As a result, the predicted values obtained from the regression model will have less deviation from the observed values, leading to higher precision.

A higher coefficient of determination in a multivariate dataset also indicates a more reliable estimate of the uncertainty or error associated with the dependent variable. When calculating the errors in a multivariate dataset, the errors from each independent variable propagate through the regression model. With a higher coefficient of determination, the regression model captures more of the variability in the dependent variable, resulting in a better estimation of the propagated errors. Consequently, the overall uncertainty or error in the dependent variable's prediction (e.g., the precision of y as a function of x) is reduced, allowing for higher precision in the analysis.

In the examples of FIGS. 17A-D, the suitability of a substrate may be evaluated based on one or more of a slope of a regression line or a correlation value derived from a plurality of tests performed on the substrate. For example, a substrate may be suitable for performing aspects of surfactant testing described herein if the values of the coefficients in a correlation algorithm (e.g., Equation 1) are sufficiently high and have low enough error (i.e., high enough precision) to conclude to a desired certainty the concentration of surfactant. In some examples, a substrate is determined to be suitable only if both the coefficients of the correlation algorithm are greater than a threshold value and precision level is higher than a threshold value.

Precision can be measured as Standard Error of the Estimate (SEE), chi-squared values, or coefficient of determination (R-squared, as shown in FIGS. 17A-17D) values, among others. R-squared measures the proportion of the variance in the dependent variable that can be explained by the independent variables in a regression model, while SEE quantifies the average amount of variation or dispersion between the observed data points and the predicted values from the regression model.

SEE is often considered a good measure of precision because it directly reflects the spread of the data points around the regression line. SEE also provides a measure of the average distance between the observed data points and the predicted values, giving an indication of how well the regression model fits the data. A smaller SEE suggests a more precise fit, as the observed values are closer to the predicted values. On the other hand, R-squared measures the goodness-of-fit of the regression model. While a high R-squared value implies a strong relationship between the variables, it does not provide information about the precision or accuracy of the predictions from the model. A high R-squared value can be achieved even if the predictions have a wide spread around the regression line, which may not be desirable in certain contexts.

SEE is generally a better measure of precision because it directly reflects the variability between the observed data points and the predicted values, providing insight into the accuracy and reliability of the regression model's estimates. R-squared, while useful for evaluating the overall goodness-of-fit, does not provide direct information about the precision of the predictions. Nonetheless, for purposes of the figures and following discussion, R-squared is discussed. It should be understood that in various examples, a variety of other metrics can be used that generally stand for the level of statistical precision of the modeled relationship between percent fill and surfactant concentration.

The level of statistical precision can also be used to produce a calculated statistical error for any particular calculation of surfactant level that is obtained based upon a percent fill level measured on a substrate. Thus an output provided by the systems and methods described herein may include not just a level of surfactant but also a standard error output that gives a confidence level to the user.

As shown in FIG. 17A, Teflon demonstrated minimal increase in % fill as the concentration of the surfactant increased from 0 ppm to 200 ppm surfactant, which is reflected by the small linear slope. Because the slope of the regression line is relatively low, this suggested that Teflon is not a suitable substrate for Plurafac® RA 300 (in this particular composition), and thus the concentration of Plurafac® RA 300 could not be accurately measured using the methods described herein with a Teflon substrate.

As shown in FIG. 17D, polysulfone demonstrated a steeper increase in % fill as the concentration of the surfactant increased from 0 ppm to 200 ppm surfactant, as reflected by a greater slope. However, the R² value associated with the regression line and observed measurements when testing on polysulfone was relatively low, as demonstrated, for example, by an unexplained increase in % fill when the concentration of the surfactant increased from 100 ppm to 200 ppm. This suggested that polysulfone is not as suitable as a substrate for Plurafac® RA 300 as compared to polycarbonate and polypropylene (discussed below), and thus the concentration of Plurafac® RA 300 may not be as accurately measured using the methods described herein with a polysulfone substrate in this particular composition.

As shown in FIGS. 17B-17C, polypropylene and polycarbonate demonstrated gradual, stepwise increases in % fill as the concentration of the surfactant increased from 0 ppm to 200 ppm. The linear slopes for each of these substrates was much higher and shows a generally regular increase in % fill as the concentration of surfactant increased. This suggested that Plurafac® RA 300 in this particular composition was compatible with the two surfaces such that the concentration of surfactant could be accurately measured with the methods described herein. Polycarbonate may be a slightly better substrate for this particular surfactant due to larger stepwise increases in % fill of the target circle as surfactant concentration increased. This may be desirable because a large stepwise increase in % fill with increasing surfactant concentration may be easier to observe. The results of this Example demonstrate the importance of compatibility between the surfactant and the substrate.

### Example 7: Evaluating Effect of Temperature on Surfactant Spread

The four samples described in Example 6 (i.e., 0 ppm, 50 ppm, 100 ppm, and 200 ppm Plurafac® RA 300) were tested at varying temperatures to measure the impact of temperature on surfactant spread. For this Example, a polycarbonate substrate was used for all samples.

Three temperatures were tested for each sample—70° F., 72° F., and 88° F. 12 three centimeter circles were drawn on polycarbonate coupons, and 200 μL of each sample was placed in three circles such that each sample was present in three circles to be tested at varying temperatures.

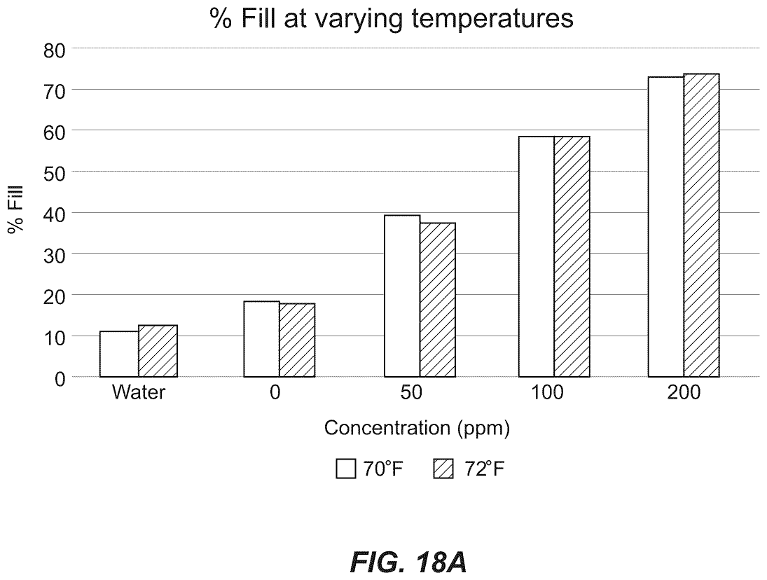

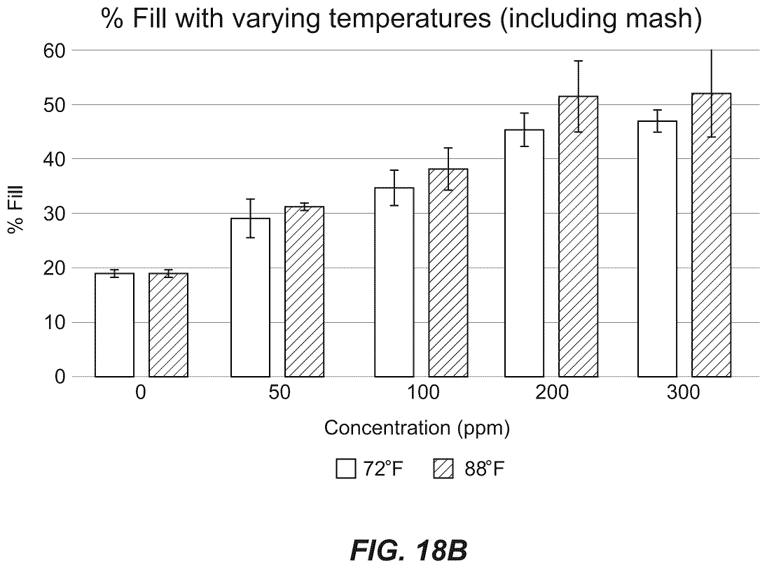

The % fill of the circle was measured for each concentration at the three temperatures, which is shown in FIGS. 18A-B. As shown in FIG. 18A, only small differences were measured in the droplet spread at temperature 70° F. compared to 72° F. However, when the temperature was elevated to 88° F., FIG. 18B shows a larger difference in the spread of the circle when comparing testing performed at 72° F. to testing performed at 88° F. This suggests that maintaining a consistent temperature (in accordance with the recommended temperature for a particular surfactant) when conducting surfactant concentration testing is important to accurately measure the concentration based on % fill of the circle on a substrate.

### Example 8: Evaluating the Impact of Dye on Surfactant Spread

Formula 2 from Example 6 was used with and without dye to measure the impact of dye on the spread of the surfactant and thus the % filled of a target circle. A 1% dye solution using Sanolin Blue powder was prepared.

200 μL of Formula 2 was placed inside of a target circle drawn on a polypropylene coupon without any dye. In a cuvette, 800 μL of Formula 2 and 1 drop of the 1% dye solution were added and shaken by hand to incorporate the dye. 200 μL of this Formula 2+ dye mixture was placed inside of a second target circle drawn on the polypropylene coupon. This protocol was repeated three times to produce four samples with dye, and four samples without dye.

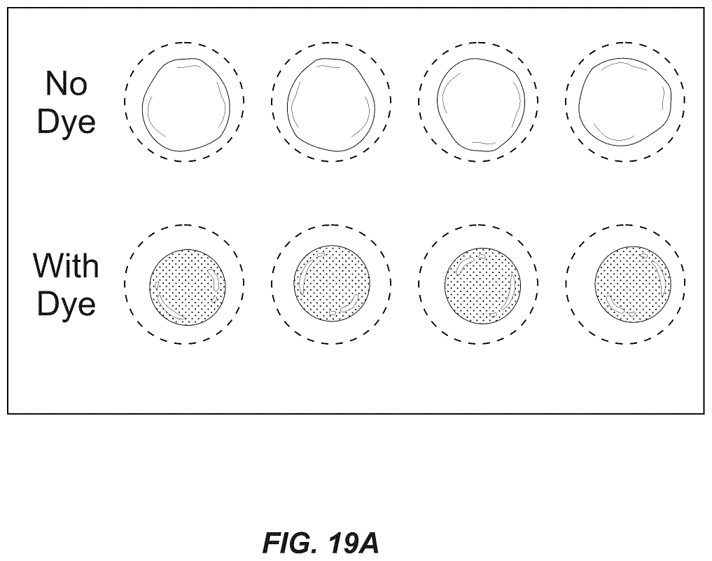

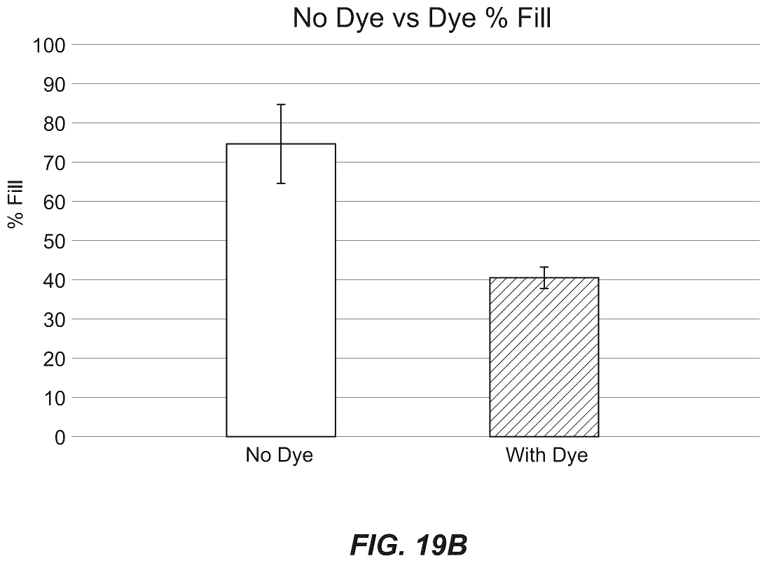

A visual representation of the droplet spread is shown in FIGS. 19A-B. The droplets with dye added spread significantly less than the droplets without dye, despite the same concentration of surfactant in all samples. This demonstrated that the addition of dye negatively impacts the spread of the surfactant.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A method of measuring a concentration of a surfactant in a composition, the method comprising:
depositing a quantity of a sample of the composition on a target region on a substrate made of a material;
obtaining an image of the sample on the target region of the substrate, and processing the image to determine a percentage fill of the target region; and
inputting the percentage fill of the target region into an algorithm based upon the material, the surfactant, and the composition to determine the concentration of the surfactant.

2. The method of claim 1, wherein the substrate is a coupon selected from the group consisting of a polycarbonate coupon, a polypropylene coupon, or a polysulfone coupon.

3. The method of claim 2, wherein depositing the sample on the substrate comprises placing one or more drops of the composition on the coupon.

4. The method of claim 3, wherein determining the concentration of the surfactant comprises measuring a spread of the one or more drops on the coupon.

5. The method of claim 4, where in the method further comprises step d) of comparing the spread of the one or more drops of the composition to a standard.

6. The method of claim 5, wherein the target region is a predetermined spread of one or more drops of a test composition that includes at least a threshold amount of surfactant.

7. The method of claim 1, wherein the substrate is an absorbent cloth, non-woven cloth, or filter paper.

8. The method of claim 7, wherein depositing the sample on the substrate comprises dipping the substrate in the composition.

9. The method of claim 7, wherein determining the concentration of the surfactant comprises measuring the distance the composition travels on the substrate.

10. The method of claim 7, wherein determining the concentration of the surfactant comprises measuring the time it takes for the composition to travel up the substrate.

11. The method of claim 10, wherein the faster the composition travels up substrate, the more surfactant there is in the composition.

12. The method of claim 1, wherein determining the concentration of the surfactant comprises using image J analysis to measure the appearance of the sample.

13. The method of claim 12, wherein the appearance of the sample correlates to surfactant concentration.

14. The method of claim 1, wherein determining the concentration of surfactant comprises using a mobile application.

15. The method of claim 14, wherein the mobile application measures droplet size on the substrate, the distance traveled on the substrate by the composition, the travel time of the composition on the substrate, or combinations thereof.

16. The method of claim 15, wherein the mobile application measures the concentration of surfactant based on the droplet size on the substrate, the distance traveled on the substrate by the composition, the travel time of the composition on the substrate, or combinations thereof.

17. The method of claim 1, wherein the composition is used in a clean-in-place (CIP) system.

18. The method of claim 17, wherein the CIP system is a food and beverage CIP system.

19. The method of claim 1, wherein the composition is a cleaning composition.

20. The method of claim 1, wherein the composition comprises at least one of carbonate, bicarbonate, detergent, and EDTA.

21. The method of claim 20, wherein the detergent is a homopolymer of acrylic acid.

22. The method of claim 1, wherein the surfactant comprises a nonionic surfactant.

23. The method of claim 1, wherein the surfactant comprises an anionic surfactant.

24. The method of claim 1, wherein the surfactant comprises a cationic surfactant.

25. The method of claim 1, wherein the surfactant comprises a zwitterionic surfactant.

26. The method of claim 1, wherein the composition is an alkaline solution.

27. The method of claim 1, wherein the composition is a neutral solution.

28. The method of claim 1, wherein the composition is an acidic solution.

29. The method of claim 1, further comprising evaluating a suitability of the substrate by performing a plurality of tests on the substrate, each test of the plurality of tests measuring a concentration of the surfactant and a spread of the surfactant.

30. The method of claim 29, wherein evaluating the suitability of the substrate by performing the plurality of tests comprises:
determining a regression fit for the plurality of tests for a particular substrate, wherein an independent variable of the regression fit is the concentration of the surfactant, and the dependent variable of the regression fit is the spread of the surfactant;
determining that a coefficient of the regression fit is greater than a first threshold value; and
determining that a level of statistical error associated with the regression fit is less than a second threshold value.

31. The method of claim 30, wherein the level of statistical error associated with the regression fit is determined by a SEE analysis.

32. The method of claim 30, wherein the level of statistical error associated with the regression fit is determined as an R-squared value.

33. The method of claim 1, wherein the algorithm is based upon the material, the surfactant, and the composition and outputs both the concentration and a level of statistical error thereof based upon the percentage fill of the target region.

34. The method of claim 1, wherein obtaining the image of the sample on the target of the substrate comprises obtaining the image with a camera communicatively coupled to a processor and a memory.

35. The method of claim 34, further comprising determining the percentage fill of the target region by identifying circles in the image obtained by the camera using an image analysis model performed by the processor according to instructions stored in the memory.

36. The method of claim 14, further comprising displaying the concentration via a display of a device implementing the mobile app.
